(19) United States
(12) Patent Application Publication
(10) Pub. No.: US 2025/0242248 A1
(43) Pub. Date: Jul. 31, 2025

(54) ONE OR MORE NON-TRANSITORY COMPUTER-READABLE MEDIA, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Tatsuya KURIHARA, Kyoto (JP); Kenta MOTOKURA, Kyoto (JP); Wataru TANAKA, Kyoto (JP)

(21) Appl. No.: 19/005,924

(22) Filed: Dec. 30, 2024

(30) Foreign Application Priority Data
Jan. 30, 2024 (JP) 2024-011588

(51) Int. Cl. A63F 13/55; G06T 15/00

(52) U.S. Cl. CPC A63F 13/55; G06T 15/005

(57) ABSTRACT

An example of an information processing system stores first volume data that is data indicating a terrain object and includes a plurality of pieces of voxel data in a first voxel space, and second volume data that is data indicating an enemy object and includes a plurality of pieces of voxel data in a second voxel space. If a destruction action on the terrain object is performed, voxel data of a voxel included in a first range in the first volume data is updated. If a destruction action on the enemy object is performed, voxel data of a voxel included in a second range in the second volume data is updated. Based on the first volume data and the second volume data, a polygon mesh is created.

### CROSS REFERENCE TO RELATED APPLICATION

This application claims priority to Japanese Patent Application No. 2024-011588 filed on Jan. 30, 2024, the entire contents of which are incorporated herein by reference.

### FIELD

The present disclosure relates to a non-transitory computer-readable storage medium having stored therein a game program, an information processing system, an information processing apparatus, and an information processing method that are capable of generating an image using voxels.

### BACKGROUND AND SUMMARY

In the prior art, there is a game where character voxels are created based on image capturing information, and polygon mesh information is generated.

In the above prior art, however, voxels are used to generate an object based on the image capturing information, and the object is not deformed by updating voxel data.

Therefore, an exemplary embodiment discloses a non-transitory computer-readable storage medium having stored therein a game program, an information processing system, an information processing apparatus, and an information processing method that are capable of deforming an object with a high degree of freedom in a game where voxels are used.

The exemplary embodiment employs the following configurations.

One or more non-transitory computer-readable media according to the exemplary embodiment are one or more non-transitory computer-readable media having stored therein instructions that, when executed, cause one or more processors of an information processing apparatus to execute image processing including: storing, in a memory, first volume data that is data for representing a first object in a virtual space and holds voxel data indicating presence of an object with respect to each voxel included in a first voxel space placed in the virtual space, and second volume data that is data for representing a second object in the virtual space and holds the voxel data with respect to each voxel included in a second voxel space placed in the virtual space. The image processing further includes, if a first event for the first object occurs based on an operation input of a player, updating in the first volume data the voxel data of a voxel included in a first range set based on a position where the first event occurs. The image processing further includes, if a second event for the second object occurs based on an operation input of the player, updating in the second volume data the voxel data of a voxel included in a second range set based on a position where the second event occurs. The image processing further includes, based on the first volume data and the second volume data, at least drawing a polygon mesh representing surfaces of the first object and the second object, thereby generating an image of the virtual space.

Based on the above, if a first event for a first object occurs, voxel data of a voxel included in a first range can be updated. If a second event for a second object occurs, voxel data of a voxel included in a second range can be updated. Consequently, it is possible to update voxel data of a voxel in a different range in accordance with the object for which the event occurs.

Further, the voxel data may include a value indicating an occupancy of an object inside a space defined by a voxel. The image processing may further include, if the first event occurs, updating the voxel data so that the degree of a voxel included in the first range decreases in the first volume data. The image processing may further include, if the second event occurs, updating the voxel data so that the degree of a voxel included in the second range decreases in the second volume data.

Based on the above, if the first event occurs, the degree of a voxel included in the first range is decreased. If the second event occurs, the degree of a voxel included in the second range is decreased. Consequently, it is possible to decrease the degree of a voxel in a different range in accordance with the object for which the event occurs, and change the shape of the object.

Further, the image processing may further include: if the first event occurs, updating the voxel data so that at least one of a plurality of voxels included in the first range in the first volume data is set to a value indicating that the first object is not present; and if the second event occurs, updating the voxel data so that at least one of a plurality of voxels included in the second range in the second volume data is set to a value indicating that the second object is not present.

Based on the above, if the first event for the first object occurs, the first object can be made absent in a first range, and if the second event for the second object occurs, the second object can be made absent in a second range. Consequently, if an event for an object occurs, it is possible to erase a range relating to the object.

Further, the image processing may further include, if the first event occurs, updating the voxel data so that a voxel completely included in the first range in the first volume data is set to a value indicating that the first object is not present, and the degree of a voxel partially included in the first range decreases. The image processing may further include, if the second event occurs, updating the voxel data so that a voxel completely included in the second range in the second volume data is set to a value indicating that the second object is not present, and the degree of a voxel partially included in the second range decreases.

Based on the above, in a voxel completely included in the above range, an object can be made absent. In a voxel partially included in the above range, a different value can be set as the degree. Consequently, for example, even in a case where a mesh indicating the shape of an object is generated using a voxel, the shape of the object after voxel data is updated can be a natural shape.

Further, the voxel data may further include material data indicating a material of an object and an amount of damage indicating caused damage. The image processing may further include, if the first event occurs, updating the amount of damage of a voxel included in the first range in the first volume data and further update a value indicating the degree of a voxel in which the amount of damage exceeds an upper limit set for the material. The image processing may further include, if the second event occurs, updating the amount of damage of a voxel included in the second range in the second volume data and further update a value indicating the degree of a voxel in which the amount of damage exceeds the upper limit set for the material.

Based on the above, if the amount of damage of a voxel exceeds an upper limit relating to a material set for the voxel, the degree of the voxel can be updated. Consequently, if an event occurs multiple times for an object, it is possible to update the degree of a voxel. For example, it is possible to destroy the object by performing a destruction action multiple times.

Further, a single voxel included in the first volume data and a single voxel included in the second volume data may be different from each other in size defined in the virtual space.

Based on the above, the size of a voxel can be varied between the first object and the second object. Thus, it is possible to vary resolution with respect to each object.

Further, the first object may be a terrain in the virtual space, and the first range may be greater than the second range.

Based on the above, the voxel size of a terrain in a virtual space can be larger than the voxel size of another object in the virtual space. Consequently, for example, when a terrain is destroyed, it is possible to destroy the terrain in a larger scale.

Further, the second object may be an object capable of moving in the virtual space by changing a position and/or an orientation of the second voxel space in the virtual space. The second range may be smaller than the first range.

Based on the above, the voxel size of the second object capable of moving in a virtual space can be made smaller than the voxel size of the first object. Consequently, for example, it is possible to destroy the second object capable of moving in the virtual space more finely when the second object is destroyed.

The image processing may further include: determining a vertex position of a polygon based on the voxel data between a voxel in which the first object or the second object is not present and a voxel in which the first object or the second object is present, thereby generating the polygon mesh; and based on occurrence of the first event or the second event, recalculating a vertex of the polygon mesh in a range including a voxel in which at least the voxel data is updated.

Based on the above, the vertices of a mesh can be recalculated by updating voxel data. Thus, it is possible to dynamically deform an object.

The image processing may further include, based on an operation input of the player, causing a player character to perform a destruction action for destroying the first object and the second object. The first event may be a state where the destruction action hits the first object. The second event may be a state where the destruction action hits the second object.

Based on the above, if a player character is caused to perform a destruction action on the first object or the second object, and the destruction action hits the object, it is possible to destroy a range relating to the object.

Another exemplary embodiment may be an information processing system that executes the above game program, or may be an information processing apparatus, or may be an information processing method.

According to the exemplary embodiment, voxel data of voxels in a different range can be updated in accordance with an object for which an event occurs.

These and other features, aspects, and advantages of the subject matter described herein will become more apparent from the following detailed description of the exemplary embodiments when taken in conjunction with the accompanying drawings.

### BRIEF DESCRIPTION OF THE DRAWINGS

FIG. 1 is an illustrative non-limiting diagram showing an example of the state where a left controller 3 and a right controller 4 are attached to a main body apparatus 2;

FIG. 2 is an illustrative non-limiting diagram showing an example of the state where each of the left controller 3 and the right controller 4 is detached from the main body apparatus 2;

FIG. 3 is illustrative non-limiting six orthogonal views showing an example of the main body apparatus 2;

FIG. 4 is illustrative non-limiting six orthogonal views showing an example of the left controller 3;

FIG. 5 is illustrative non-limiting six orthogonal views showing an example of the right controller 4;

FIG. 6 is an illustrative non-limiting block diagram showing an example of the internal configuration of the main body apparatus 2;

FIG. 7 is an illustrative non-limiting block diagram showing an example of the internal configurations of the main body apparatus 2, the left controller 3, and the right controller 4:

FIG. 8 is an example non-limiting diagram showing an example of a terrain object as a voxel object;

FIG. 9 is an example non-limiting diagram showing examples of the states before and after a part of the terrain object shown in FIG. 8 is deleted;

FIG. 10 is an example non-limiting diagram showing examples of the states before and after a part of the terrain object shown in FIG. 8 is deleted;

FIG. 11 is an example non-limiting diagram showing an example of the content of voxel data;

FIG. 12 is an example non-limiting diagram showing an example of property information indicating the property of a material;

FIG. 13 is an example non-limiting diagram showing an example of texture information indicating the texture of a material;

FIG. 14 is an example non-limiting diagram showing an example of a method for generating a mesh;

FIG. 15 is an example non-limiting diagram showing an example of a game image including a terrain object;

FIG. 16 is an example non-limiting diagram showing an overall schematic diagram of a game space in a game according to the exemplary embodiment;

FIG. 17 is an example non-limiting diagram showing an example of a game image of the game space viewed from a virtual camera, and an image displayed on a display device;

FIG. 18 is an example non-limiting diagram showing an example of a voxel space VLa placed in a field voxel space;

FIG. 19 is an example non-limiting diagram showing an example of a voxel space VLb placed in the field voxel space;

FIG. 20 is an example non-limiting diagram showing an example of the destruction range of a rock object A as a terrain object;

FIG. 21 is an example non-limiting diagram showing an example of the destruction range of an enemy object B;

FIG. 22 is an example non-limiting diagram illustrating an example of a destruction process on a voxel included in a first destruction range;

FIG. 23 is an example non-limiting diagram showing an example of the shape of the rock object A after being destroyed by the destruction process;

FIG. 24 is an example non-limiting diagram showing an example of the shape of the enemy object B after being destroyed by the destruction process;

FIG. 25 is an example non-limiting diagram showing examples of various pieces of data used in information processing by a game system 1;

FIG. 26 is an example non-limiting flow chart showing an example of the flow of game processing executed by the game system 1; and

FIG. 27 is an example non-limiting flow chart showing an example of a voxel data update process in step S7.

### DETAILED DESCRIPTION OF NON-LIMITING EXAMPLE EMBODIMENTS

### [1. Configuration of Game System]

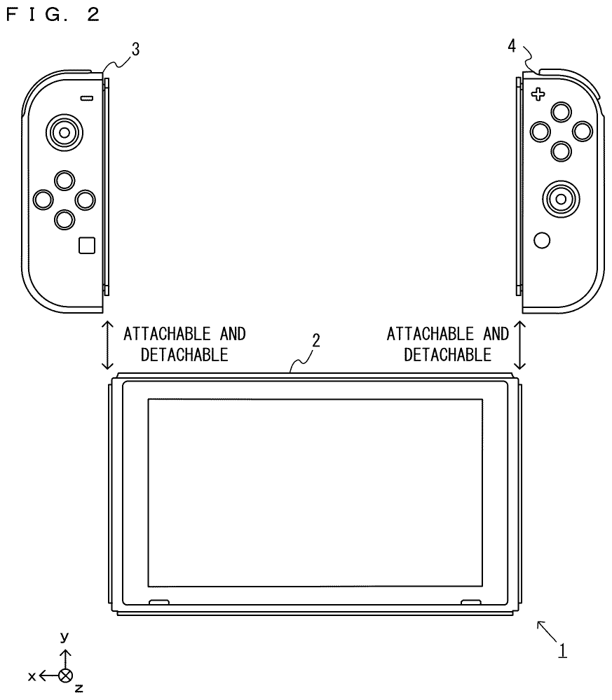

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

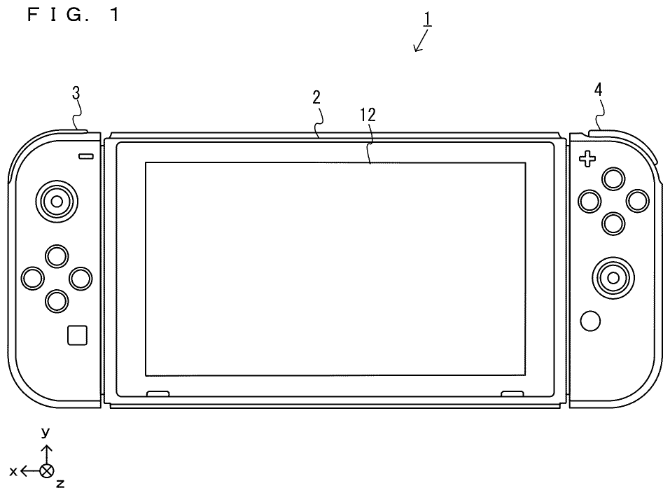

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

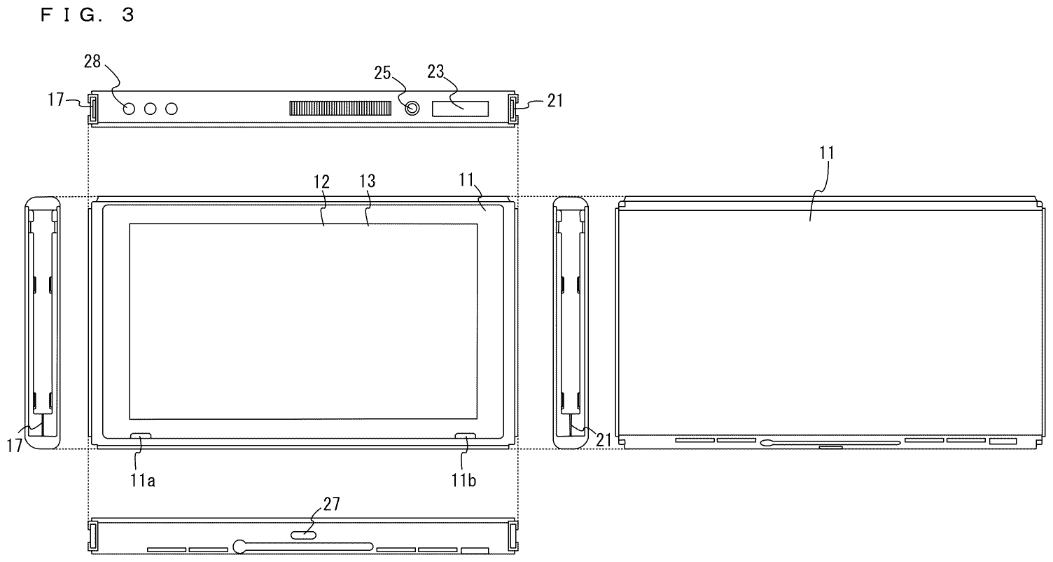

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

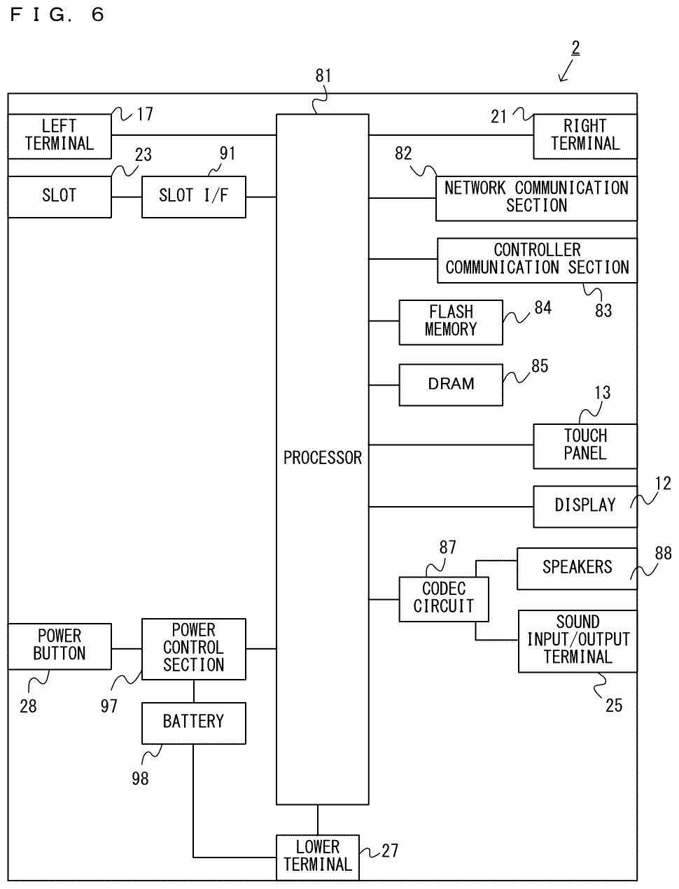

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

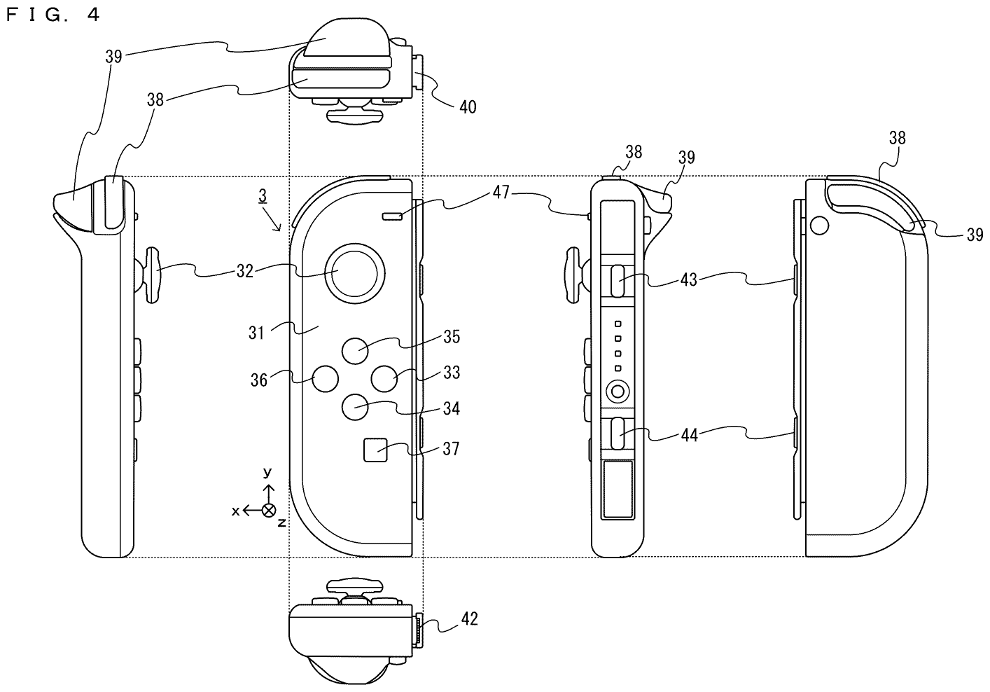

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

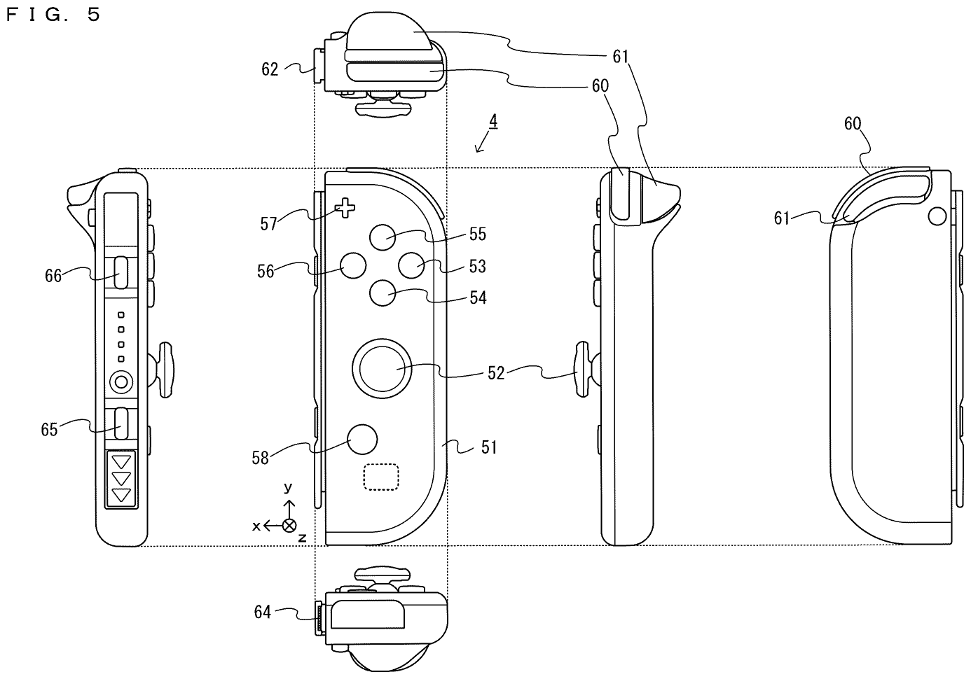

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

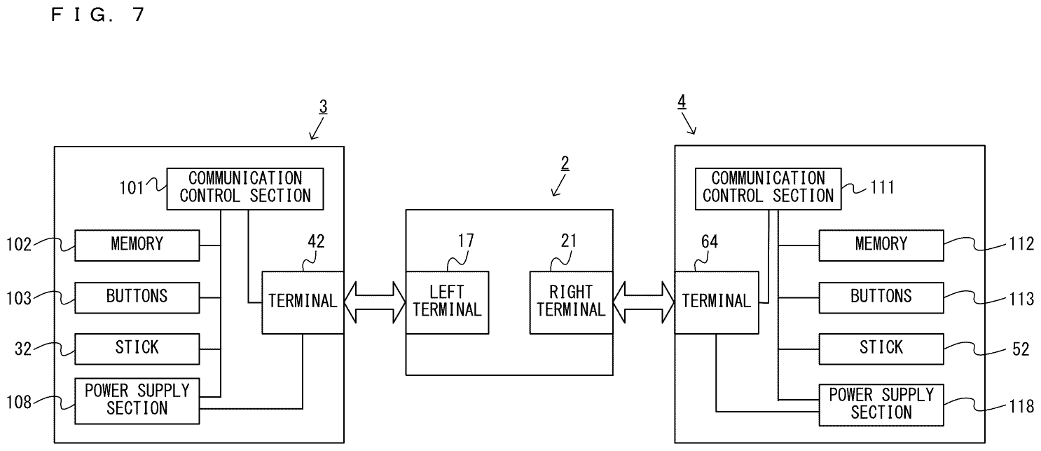

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

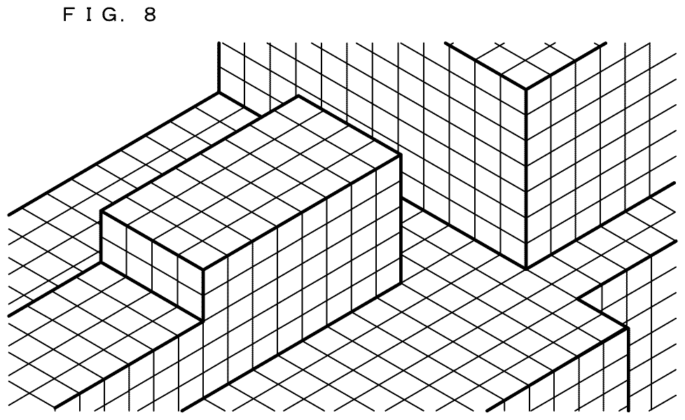

Next, referring to FIG. 8 to FIG. 15, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a monitor.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, for each of a plurality of voxels that are set in the game space, the game system 1 stores voxel data as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and in practice, there is no need for edges of the terrain object to be drawn thick.

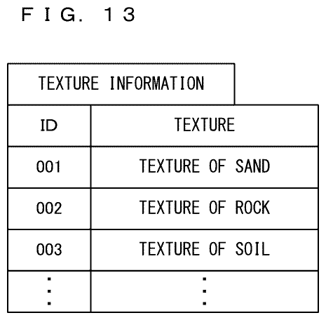

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object in FIG. 8 is shown for the purpose of illustrating the relationship between voxels and voxel objects in an easy-to-understand manner. In the present embodiment, in practice, a voxel object is generated by such a rule that results in a terrain object having a complicated shape in comparison with the cubic voxels (e.g., based on the voxel data), such as a terrain object shown in FIG. 14 to be described below, for example. Note that there is no limitation on the rule for determining the shape of the voxel object based on the voxel data. In other embodiments, the game system 1 may generate a voxel object as shown in FIG. 8 based on the voxel data or may generate a voxel object as shown in FIG. 15 based on the voxel data.

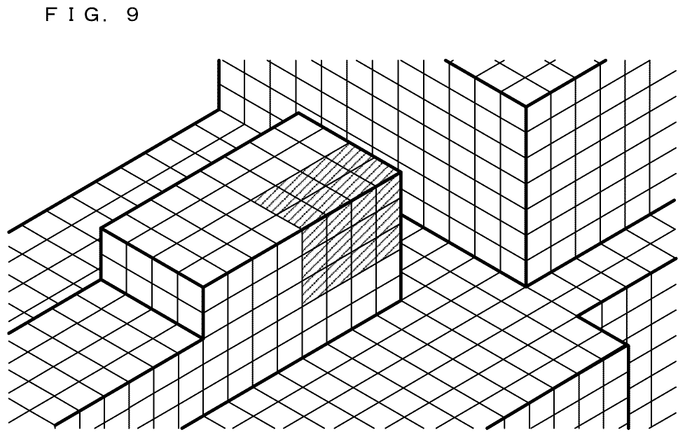

It is possible to change the shape of a voxel object by changing voxel data of voxels. FIG. 9 and FIG. 10 are views showing before and after the deletion of a portion of the terrain object shown in FIG. 8. That is, when the hatched portion of the terrain object shown in FIG. 9 is destroyed, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, in a case where the shape of a terrain object may be changed as a result of the terrain object in a game being broken for some reason (e.g., the player object striking the terrain object), the game system 1 can freely change the shape of the terrain object by changing the voxel data used to generate the terrain object, rather than directly changing data representing the outer shape of the terrain object (e.g., the mesh to be described below).

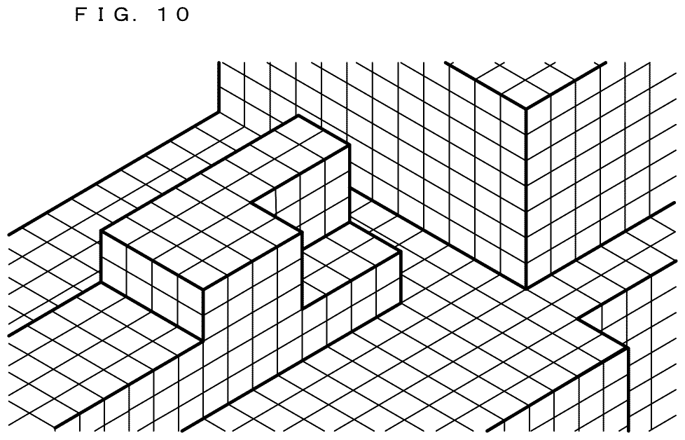

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data is data of a density indicating the degree to which an object is included in the region defined by each voxel. As will be described in detail below, the position and the shape of the surface of the voxel object (e.g., the mesh to be described below) are determined based on this density. In other words, in the present embodiment, this density is also data used to generate a mesh that defines the surface of the voxel object.

In the present embodiment, the density can take an integer value in the range from the lower limit value (e.g., 0) to the upper limit value (e.g., 255). In the present embodiment, in the game system 1, when the density value set for the voxel is high, the proportion of the volume to be occupied by the voxel object in the voxel is high. When the density value is low, the proportion is low. For example, if the density is 0, there is no object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, there is a case where the method of generating a voxel object as shown in FIG. 8 and the method of generating a voxel object as shown in FIG. 15 differ in volume, even if they are based on the same density.

In other embodiments, the density may indicate either a state in which the voxel object occupies the entirety of the region within the voxel or a state in which no voxel object is included in the region within the voxel. For example, the density data may be data that can take only either 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

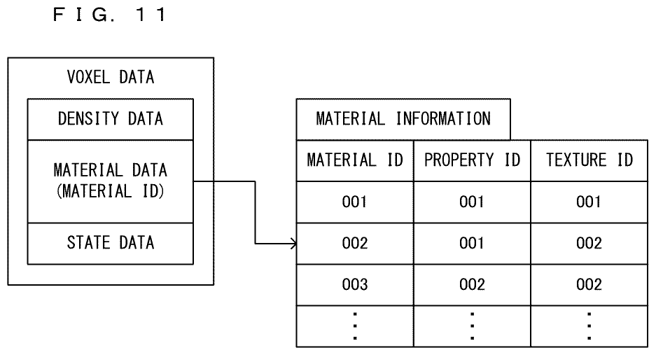

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that the specific content of the property is optional, and for example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

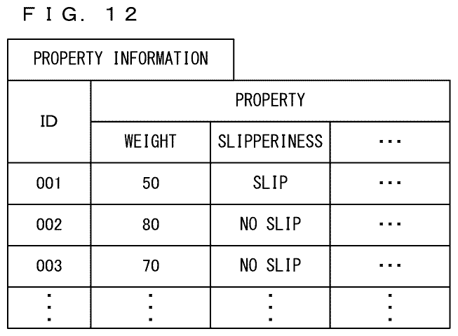

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for a voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value (e.g., 128), and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the object, or a voxel with a density of 255 may partially include a region outside the object. Since voxels with densities less than the reference value are treated as being outside the object in the present embodiment, there are fewer vertices as compared with a case where those voxels are treated as being inside the object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel corresponding to the voxel data (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### (Overview of Game Processing)

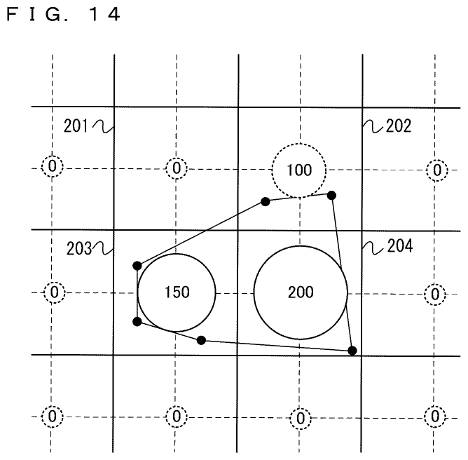

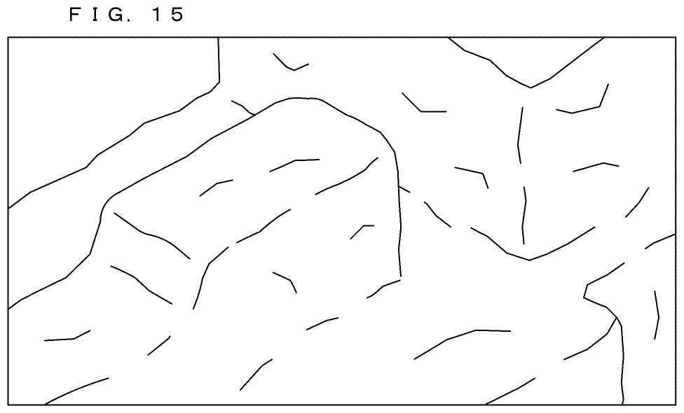

Next, a description is given of a voxel object placed in a game space when a game according to the exemplary embodiment is executed. FIG. 16 is a diagram showing an overall schematic diagram of a game space in the game according to the exemplary embodiment. FIG. 17 is a diagram showing an example of an image of the game space viewed from a virtual camera, and a game image displayed on a display device.

In the game according to the exemplary embodiment, a plurality of game stages are prepared, and a game space is set with respect to each game stage. For example, the plurality of game stages include a game stage of a rock pile, a game stage of a volcano, a game stage of wilderness, and the like. For example, FIG. 16 shows the game stage of a rock pile and shows a diagram of the game stage viewed from above in the game space.

As shown in FIG. 16, in the game space, a player character PC is placed. In accordance with an operation of a player, the player character PC moves in the game space or performs various actions such as a jump and a punch in the game space. The player character PC is not a voxel object, and is a 3D object the shape of which is defined in advance by polygons.

If the game is started, a fixed voxel space defined by an Xs-Ys-Zs coordinate system is set as a voxel space representing a field in the game space. The axis directions of the Xs-Ys-Zs coordinate system are parallel to those of an XYZ coordinate system of the game space. That is, a Ys axis is an axis directed upward in the game space, and an Xs axis and a Zs axis are axes perpendicular to the Ys axis. Hereinafter, the voxel space defined by the Xs-Ys-Zs coordinate system will occasionally be referred to as a “field voxel space”. The position of each object present in the game space is represented by coordinate values in the Xs-Ys-Zs coordinate system. Although the direction of the Xs-Ys-Zs coordinate system representing the field voxel space match that of the XYZ coordinate system representing the game space here, these directions may not match each other.

In the field voxel space, terrain objects are set as voxel objects. For example, as the terrain objects, a terrain object 210 representing the ground and a terrain object 220 representing a rock pile are set. For example, material data indicating a rock is set in voxel data of each voxel located in a lower portion in the field voxel space, thereby forming the terrain object 210 representing the ground composed of rocks. Material data indicating a rock is set in pieces of voxel data of a plurality of voxels located above the ground in the field voxel space, thereby forming the terrain object 220 representing a rock pile raised from the ground.

The terrain object 210 representing the ground and the terrain object 220 representing a rock pile can be destroyed by the player character PC. Voxel data of a voxel in the field voxel space is updated, whereby the terrain objects 210 and 220 are destroyed. The destruction of the objects will be described below.

As shown in FIGS. 16 and 17, in the game space, a rock object A is placed. The rock object A is a type of terrain object and is destroyed by the player character PC, held by the player character PC, or thrown by the player character PC.

Specifically, the rock object A is a voxel object different from the terrain objects 210 and 220 defined by the field voxel space. The shape of the rock object A is prescribed by pieces of voxel data of a plurality of voxels in a voxel space VLa. The voxel space VLa is a voxel space placed in the game space and different from the field voxel space and is defined by an Xa-Ya-Za coordinate system. In the pieces of voxel data of the plurality of voxels in the voxel space VLa, the value of a density indicating that an object is present and material data indicating a rock are set. As described above, a polygon mesh is generated and drawn based on voxel data of each voxel, whereby the rock object A is displayed. In FIGS. 16 and 17, the voxel space VLa is indicated by a dotted line for illustrative purposes, but actually, the dotted line indicating the voxel space VLa is not displayed during the game.

The voxel space VLa can be moved in the game space, and the direction of the voxel space VLa can be changed in the game space. For example, if the player character PC performs the action of throwing the rock object A, the voxel space VLa is moved in the game space, whereby the rock object A moves in the game space while maintaining its shape. The voxel space VLa is rotated in the game space, whereby the rock object A rotates in the game space.

The rock object A may be destroyed by, for example, a destruction action of the player character PC. If the destruction action on the rock object A is performed, a part or the entirety of the rock object A is erased, or a part of the rock object A is separated. Specifically, voxel data of each voxel in the voxel space VLa is rewritten, whereby the rock object A is destroyed. The destruction of the rock object A will be described in detail below.

The rock object A may be placed in advance in the game space. For example, initial data for forming the terrain object 210 representing the ground and the terrain object 220 representing a rock pile as shown in FIG. 16 are stored in an internal storage medium such as the flash memory 84 or an external storage medium attached to the slot 23. The initial data may include the rock object A. That is, the rock object A may be an object stored as the initial data and initially placed in the game space. In this case, the voxel space VLa is defined in advance in the initial data.

Alternatively, the rock object A may not be included in the initial data, and may be generated in the execution process of the game. For example, based on the initial data, the terrain object 210 representing the ground and the terrain object 220 representing a rock pile are generated, and the game is started. In the execution process of the game, for example, based on the destruction action (e.g., the action of throwing a punch or firing a bullet) of the player character PC, a part of the terrain object 210 representing the ground or the terrain object 220 representing a rock pile is destroyed. By this destruction, a part of the terrain object 210 or the terrain object 220 may be separated, and the separated part may be generated as the rock object A. In this case, the voxel space VLa is not defined in advance in the initial data. When the terrain object 210 or the terrain object 220 is destroyed and the debris from the destruction is generated as the rock object A, the voxel space VLa is defined.

As shown in FIGS. 16 and 17, in the game space, an enemy object B is placed. The enemy object B is a character automatically controlled by the processor 81 and moves in the game space, changes its orientation, or attacks the player character PC.

The enemy object B is a voxel object. The shape of the enemy object B is prescribed by pieces of voxel data of a plurality of voxels in a voxel space VLb. The voxel space VLb is a voxel space placed in the game space and different from the field voxel space and is defined by an Xb-Yb-Zb coordinate system. In the pieces of voxel data of the plurality of voxels in the voxel space VLb, the value of a density indicating that an object is present and material data indicating the enemy object are set. Consequently, the enemy object B is formed. As described above, a polygon mesh is generated and drawn based on voxel data of each voxel, whereby the enemy object B is displayed. In FIGS. 16 and 17, the voxel space VLb is indicated by a dotted line for illustrative purposes, but actually, the dotted line indicating the voxel space VLb is not displayed during the game.

The hands, the feet, and the parts of the face (the mouth and the eyes) of the enemy object B are not voxel objects but 3D objects the shapes of which are defined in advance by polygons. A torso portion (an ellipse-shaped portion in FIG. 17) of the enemy object B is a voxel object, and the shape of the torso portion is prescribed by generating a mesh based on voxel data as described above. Then, the 3D objects representing the hands, the feet, and the parts of the face are pasted to the generated mesh (the torso portion), thereby forming the enemy object B.

The voxel space VLb can be moved in the game space, and the direction of the voxel space VLb can be changed in the game space. For example, if the voxel space VLb is moved in the game space by the processor 81, the enemy object B moves in the game space. The voxel space VLb is rotated in the game space, whereby the enemy object B rotates.

The enemy object B may be destroyed by, for example, the destruction action of the player character PC. Specifically, voxel data of each voxel in the voxel space VLb is rewritten, whereby the enemy object B is destroyed. The destruction of the enemy object B will be described in detail below.

In the game space, a weapon object C is also placed. The weapon object C is held, for example, by the enemy object B. The weapon object C is also a voxel object. The shape of the weapon object C is prescribed by pieces of voxel data of a plurality of voxels in a voxel space VLc. The voxel space VLc is a voxel space placed in the game space and different from the field voxel space and is defined by an Xc-Yc-Zc coordinate system. The weapon object C is also moved in the game space, and the direction of the weapon object C is also changed in the game space. For example, if the enemy object B performs the action of swinging the weapon object C or the action of throwing the weapon object C, the position and/or the orientation of the voxel space VLc in the game space are changed. Consequently, the weapon object C is moved in the game space, or the orientation of the weapon object C is changed. For example, in FIG. 17, the Xc-Yc-Zc coordinate system is tilted relative to the game space, and the weapon object C is tilted in the game space.

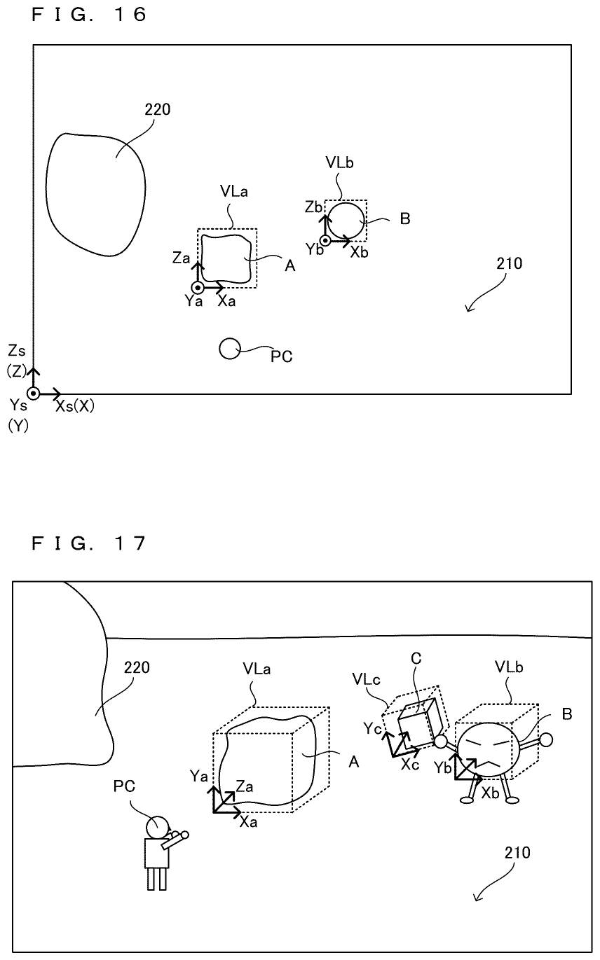

FIG. 18 is a diagram showing an example of the voxel space VLa placed in the game space. As shown in FIG. 18, the voxel space VLa is defined by an Xa axis, a Ya axis, and a Za axis. The position of each voxel in the voxel space VLa is represented by coordinate values along the Xa, Ya, and Za axes. A single voxel in the voxel space VLa is a cube area a side of which has a predetermined length. Here, in the game space, a length is defined, and for example, “m (meter)” is used as a length unit. For example, the height of the player character PC in the game space may be defined as 2 m. The length of a side of a single voxel in the voxel space VLa is, for example, “1 m” in the game space. A single voxel in the field voxel space is also a cube, and the length of a side of the cube is “1 m”.

In each voxel in the voxel space VLa, voxel data including the above density, material data, and state data is set. As shown in FIG. 18, for example, if the value of the density indicating that an object is present and the material data indicating a rock are set in pieces of voxel data of 125 (=5 (depth)×5 (width)×5 (height)) voxels in the voxel space VLa, the rock object A having a depth, a width, and a height of about 5 m is formed in the game space. For example, in a case where a mesh is generated, the density may be set to 255 for a voxel relating to the inside of the object among the 125 voxels, and the density may be set to a value in the range from 128 to 254 (or from 1 to 255) for a voxel relating to the surface of the object among the 125 voxels. The position of the origin of the voxel space VLa and the directions of the axes (the Xa, Ya, and Za axes) of the voxel space VLa in the game space are changed, whereby the position and the orientation of the rock object A in the game space are changed.

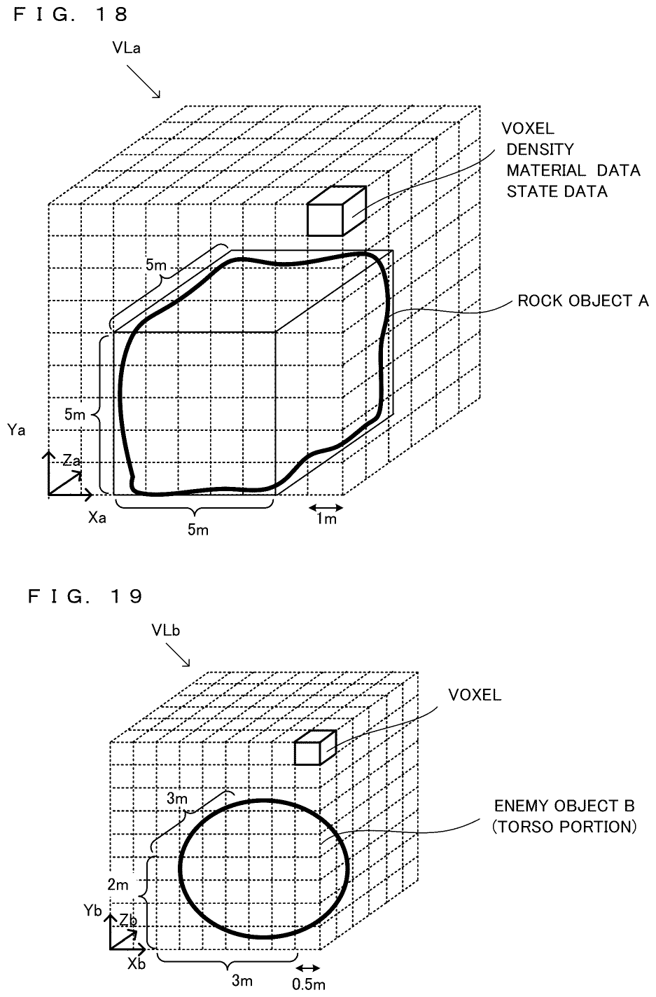

FIG. 19 is a diagram showing an example of the voxel space VLb placed in the game space. As shown in FIG. 19, the voxel space VLb is defined by an Xb axis, a Yb axis, and a Zb axis. The position of each voxel in the voxel space VLb is represented by coordinate values along the Xb, Yb, and Zb axes. A single voxel in the voxel space VLb is smaller than a single voxel in the voxel space VLa (or the field voxel space). For example, the length of a side of a single voxel in the voxel space VLb is “0.5 m” in the game space. Thus, in the voxel space VLb, for example, if the value of the density indicating that an object is present and the material data indicating the enemy object B are set in pieces of voxel data of a plurality of voxels included in a range illustrated as an elliptical shape having a depth and a width of 3 m and a height of 2 m, the torso portion of the enemy object B of approximately an elliptical shape having a depth and a width of about 3 m and a height of about 2 m is formed in the game space. For example, the density may be set to 255 for a voxel relating to the inside of the torso among the plurality of voxels, and the density may be set to a value in the range from 1 to 254 for a voxel relating to the front surface of the torso among the plurality of voxels. The position of the origin of the voxel space VLb and the directions of the axes (the Xb, Yb, and Zb axes) of the voxel space VLb in the game space are changed, whereby the position and the orientation of the enemy object B in the game space are changed.

Although not shown in the figures, the voxel space VLc for representing the weapon object C is defined by an Xc axis, a Yc axis, and a Zc axis. A single voxel in the voxel space VLc is smaller than a single voxel in the voxel space VLa (or the field voxel space), and the length of a side of a single voxel in the voxel space VLc may be, for example, “0.5 m”, or may be a value shorter or longer than “0.5 m”. The position of the origin of the voxel space VLc and the directions of the axes (the Xc, Yc, and Zc axes) of the voxel space VLc in the game space are changed, whereby the position and the orientation of the weapon object C in the game space are changed.

Next, the destruction of each object is described. In the exemplary embodiment, the range to be destroyed differs between a case where the destruction action is performed on a terrain object and a case where the destruction action is performed on the enemy object.

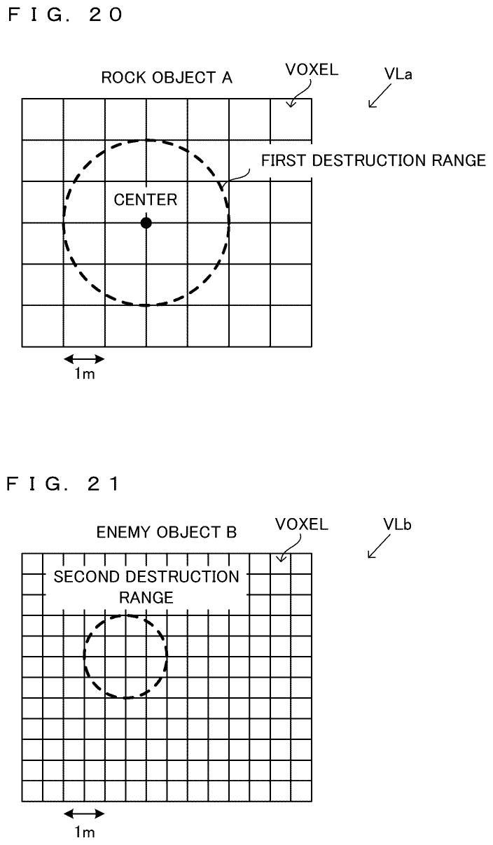

FIG. 20 is a diagram showing an example of the destruction range of the rock object A as a terrain object. FIG. 21 is a diagram showing an example of the destruction range of the enemy object B. In FIG. 20, each voxel when the voxel space VLa is viewed in a planar manner is indicated as a square. Similarly, in FIG. 21, each voxel when the voxel space VLb is viewed in a planar manner is indicated as a square.

In a case where the destruction action (e.g., a punch, a kick, the firing of a bullet, or the like) is performed by the player character PC, and if the destruction action hits the rock object A as a terrain object, a first destruction range is set. As shown in FIG. 20, the first destruction range is set based on the position hit by the destruction action. For example, the first destruction range is set with the position hit by the destruction action as its center. For example, if a punch is thrown as the destruction action, the first destruction range in the voxel space VLa is set with a position in the voxel space VLa relating to the position of the first (or the vicinity of the first) of the player character PC in the game space as its center. Then, a destruction process described below is performed on each voxel in the voxel space VLa included in the first destruction range. The first destruction range is, for example, a sphere having a diameter of 4 m.

Specifically, the determination of whether or not a voxel is included in the first destruction range is made based on a SDF (Signed Distance Field). For example, a range where the distance from the center has a negative value with respect to the diameter is represented as the inside of the shape, and a range where the distance has a positive value is represented as the outside of the shape. In a case where the destruction action is performed by the player character PC, and if the destruction action hits the rock object A, based on a Signed Distance from the position hit by the destruction action, it is determined whether or not each voxel in the voxel space VLa is in the first destruction range. Then, regarding a voxel in the first destruction range, voxel data is updated as the destruction process.

In a case where the destruction action is performed by the player character PC, and if the destruction action hits the enemy object B, as shown in FIG. 21, a second destruction range is set based on the position hit by the destruction action. For example, the second destruction range is set with the position hit by the destruction action as its center. For example, if a punch is thrown as the destruction action, the second destruction range is set with a position in the voxel space VLb relating to the position of the first (or the vicinity of the first) of the player character PC in the game space as its center. Then, the destruction process is performed on each voxel in the voxel space VLb included in the second destruction range. The second destruction range is, for example, a sphere having a diameter of 2 m.

Also the second destruction range is determined based on the SDF, similarly to the first destruction range. In a case where the destruction action is performed by the player character PC, and if the destruction action hits the enemy object B, based on a Signed Distance from the position hit by the destruction action, it is determined whether or not each voxel in the voxel space VLb is in the second destruction range. Then, regarding a voxel in the second destruction range, voxel data is updated as the destruction process.

As described above, the destruction range differs depending on the type of the object hit by the destruction action. In a case where the destruction action hits the enemy object B, the destruction range is smaller than that in a case where the destruction action hits a terrain object. The sizes and the shapes of the first destruction range and the second destruction range are merely examples, and are not limited to those described above. The first destruction range and the second destruction range may not be constant, and the shapes and the sizes of the first destruction range and the second destruction range may be changed based on the type of the destruction action, the position hit by the destruction action, the situation of the surroundings, or the like.

For example, in a case where a terrain object is formed to be raised from the ground, and if the destruction action hits the raised portion, the first destruction range is set based on the position hit by the destruction action. The destruction range does not necessarily need to have a spherical shape, and may have any shape. For example, the destruction range may be a range where the bottom surface has a flat shape.

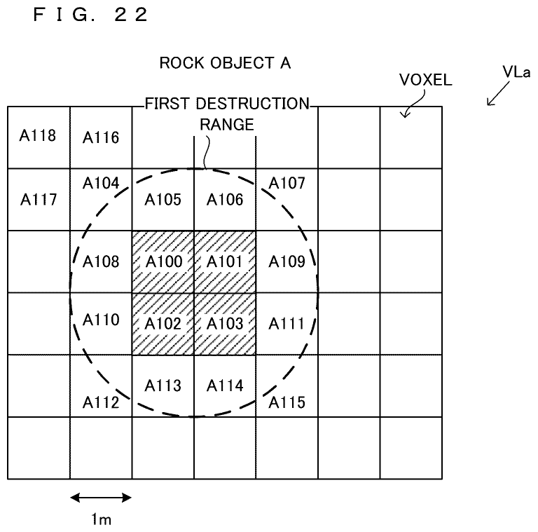

FIG. 22 is a diagram illustrating an example of a destruction process on a voxel included in the first destruction range.

As shown in FIG. 22, if the destruction action hits the rock object A, voxel data of a voxel in the voxel space VLa included in the first destruction range based on the position hit by the destruction action is updated. Specifically, voxel data of a voxel completely included in the first destruction range is rewritten with a value indicating that an object is not present. Here, in FIG. 22, voxels completely included in the first destruction range are voxels A100, A101, A102, and A103. That is, if the entire area of a certain voxel is included in the first destruction range, the voxel is completely included in the first destruction range. Then, in pieces of voxel data of the voxels A100, A101, A102, and A103 completely included in the first destruction range, a value indicating that an object is not present is set. More specifically, the densities of the voxels A100, A101, A102, and A103 completely included in the first destruction range are set to “0”.

Voxel data of a voxel partially included in the first destruction range is also updated. Specifically, the density of the voxel partially included in the first destruction range is decreased to a value smaller than the upper limit value. For example, the density of the voxel is set to the range from 1 to 254. The voxel partially included in the first destruction range is a voxel a partial area of which is included in the first destruction range, and the other partial area of which is not included in the first destruction range. For example, in FIG. 22, voxels partially included in the first destruction range are voxels A104, A105, A106, A107, A108, A109, A110, A111, A112, A113, A114, and A115.

For example, the range of decrease in the density of a voxel partially included in the first destruction range may differ in accordance with the size of the area included in the first destruction range. For example, the larger the area included in the first destruction range is, the greater or the smaller the range of decrease in the density may be. The range of decrease in the density of a voxel partially included in the first destruction range may be the same regardless of the relative size of the area included in the first destruction range. The density of a voxel partially included in the first destruction range may be set to “0”, similarly to a voxel completely included in the first destruction range.

On the other hand, pieces of voxel data of voxels that are not included in the first destruction range, such as voxels A116, A117, and A118, are not changed. That is, the density of a voxel that is not included in the first destruction range is maintained. Voxel data of a voxel (e.g., voxels A116 and A117) adjacent to a voxel partially included in the first destruction range may be changed, and voxel data of a voxel (e.g., a voxel A118) that is not adjacent a voxel partially included in the first destruction range may not be changed.

As described above, voxel data (specifically, the density) of a voxel completely included in the first destruction range is set to a value indicating that an object is not present. That is, the rock object A is erased from an area completely included in the first destruction range. Voxel data (specifically, the density) of a voxel partially included in the first destruction range is decreased to a value less than the upper limit value. As described above with reference to FIG. 14, the shape of the surface of a voxel object is prescribed in accordance with the density. As described above, voxel data (specifically, the density) of each voxel for forming the rock object A is updated, and the surface (the mesh) of the rock object A is updated based on the updated voxel data. Thus, the shape of the surface of the rock object A after the destruction process is not a smooth spherical surface as the surface in the first destruction range, and is a somewhat uneven natural shape.

In FIG. 22, the destruction process on a voxel included in the first destruction range has been described taking the rock object A as an example of a terrain object. The same applies to another terrain object. For example, if the destruction action is performed on the terrain object 210 defined as voxels in the field voxel space by the player character PC (or the enemy object B), the first destruction range is set based on the position hit by the destruction action. For example, if a punch is thrown as the destruction action by the player character PC, the first destruction range in the field voxel space is set with a position in the field voxel space relating to the position of the first (or the vicinity of the first) of the player character PC in the game space as its center. The density of a voxel in the field voxel space completely included in the first destruction range is set to a value indicating that an object is not present (e.g., “0”). The density of a voxel in the field voxel space partially included in the first destruction range is decreased to a value less than the upper limit value. The same applies to a case where the destruction action is performed on the terrain object 220 defined in the field voxel space.

Also if the destruction action is performed on the enemy object B, the same process is performed, although the destruction range is different. That is, if the destruction action is performed on the enemy object B, the density of a voxel completely included in the second destruction range determined based on the position hit by the destruction action is set to a value indicating that an object is not present. For example, the density of the voxel completely included in the second destruction range is set to “0”. The density of a voxel partially included in the second destruction range is decreased to a value less than the upper limit value and greater than “0”.

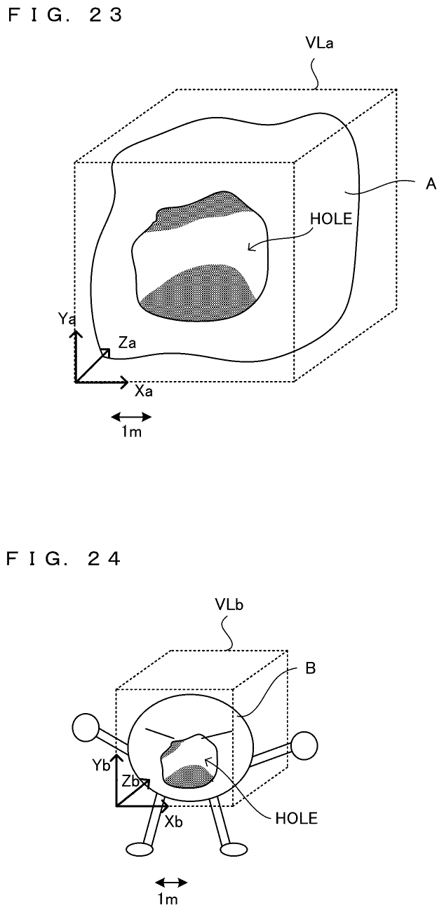

FIG. 23 is a diagram showing an example of the shape of the rock object A after being destroyed by the destruction process. FIG. 24 is a diagram showing an example of the shape of the enemy object B after being destroyed by the destruction process.

As shown in FIG. 23, if voxel data of a voxel in the first destruction range is updated by performing the destruction action on the rock object A, a part of the rock object A is destroyed and changes to a shape in which the part has a hole. The size of a hole (a cavity) in the rock object A is relatively large. For example, the diameter of a hole in the rock object A is about 4 m in the game space.

As shown in FIG. 24, if voxel data of a voxel in the second destruction range is updated by performing the destruction action on the enemy object B, a part of the enemy object B is destroyed and changes to a shape in which the part has a hole. The size of a hole (a cavity) in the enemy object B is smaller than a hole in the rock object A. For example, the diameter of a hole in the enemy object B is about 2 m in the game space.

As described above, the destruction range is varied in accordance with the object hit by the destruction action, whereby in accordance with the type of the object hit by the destruction action, it is possible to efficiently (quickly) destroy the object, or when the object is destroyed, it is possible to cause the player to feel a response from the destruction. For example, if the destruction action hits a terrain object, the destruction range is made great, whereby it is possible to destroy a wider range by a single destruction action (e.g., a punch) and efficiently destroy the terrain.

Generally, the enemy object B is smaller than a terrain object, but if a wide destruction range is destroyed by a single destruction action on the enemy object B similarly to the terrain object, the enemy object B may be easily destroyed. In the exemplary embodiment, in a case where the destruction action hits the enemy object B, the destruction range is smaller than in a case where the destruction action hits a terrain object, and a narrow range is destroyed by a single destruction action. Consequently, it is possible to prevent the enemy object B from being easily destroyed and obtain a response from an attack on the enemy object B. The enemy object B is represented by voxel data, and the voxel data is changed in accordance with the destruction action, whereby it is possible to represent the process of destroying (the process of attacking) the enemy object B. Additionally, the destruction range is made small, whereby it is possible to display the state where the enemy object B is gradually destroyed.

In the exemplary embodiment, the voxel resolution of the enemy object B is set to be higher than the voxel resolution of a terrain object. Specifically, the length of a side of each voxel in the voxel space VLb for representing the enemy object B is, for example, 0.5 m in the game space. On the other hand, the length of a side of each voxel in the voxel space (the voxel space VLa or the field voxel space) for representing a terrain object is, for example, 1 m in the game space. As described above, the voxel resolution of the enemy object B is higher than the voxel resolution of a terrain object, whereby it is possible to represent the shape of the enemy object B more finely. When the enemy object B is destroyed, it is possible to represent the process of the destruction more finely.

If the destruction action of the player character PC hits the weapon object C held by the enemy object B, the second destruction range may be set, or a third destruction range smaller or greater than the second destruction range may be set. Then, voxel data of a voxel included in the set destruction range may be changed, whereby the weapon object C may be destroyed. A plurality of types of enemy objects represented by voxel data may appear in the game space, and a destruction range having a different size may be set with respect to each type of enemy object. Also if the destruction action hits another object capable of moving in the game space and represented by voxel data, a destruction range having a size different from that of a terrain object may be set. The destruction range of the object capable of moving in the game space may be smaller than the destruction range of the terrain object. The voxel resolution of the object capable of moving in the game space may be higher than the voxel resolution of the terrain object.

In the above description, if the destruction action is performed on a terrain object, the first destruction range is set. Alternatively, the destruction range may differ in accordance with the terrain object. For example, the destruction range may differ in accordance with the type of the terrain object (a material such as a rock, soil, or sand), or the destruction range may differ in accordance with the size of the terrain object. For example, the destruction range may differ between a terrain object fixed in the game space (e.g., the terrain object 210 representing the ground or the terrain object 220 representing a rock pile) and a terrain object capable of moving in the game space (the rock object A). For example, the destruction range of the terrain object capable of moving in the game space may be smaller than the destruction range of the terrain object fixed in the game space. The voxel resolution of the terrain object capable of moving in the game space may be higher than the voxel resolution of the terrain object fixed in the game space.

In the exemplary embodiment, if the destruction action hits a voxel object, it is not that the destruction process (the update of the density) is always performed on a voxel included in the destruction range based on the position hit by the destruction action. The density of the voxel included in the destruction range is updated in accordance with the “fragility” of a material (a substance) in the material data set in the voxel. Specifically, the density of the voxel included in the destruction range may or may not be updated in accordance with “the hardness of the destroying side”, “the hardness of the destruction target side”, and the “amount of damage” of the voxel.

More specifically, “the hardness of the destroying side” differs in accordance with the type of the destruction action. For example, “the hardness of the destroying side” is determined in the range from 1 to 5 in accordance with the type of the destruction action (a punch, a kick, the firing of a bullet, the throwing of a rock, or the like). As described above, voxel data includes the material data, and “fragility” is set as the property of the material. Specifically, the “fragility” is determined based on “hardness” and an “endurance value” set in advance for the material. That is, “the hardness of the destruction target side” is hardness set for the material of the voxel object hit by the destruction action, and is determined, for example, in the range from 1 to 5. For example, the hardness of a rock is set in advance to “3”, and the hardness of iron is set in advance to “5”. The amount of damage of the voxel is stored as the state data in voxel data, and for example, changes in the range from 0 to 15.

If “the hardness of the destroying side” is greater than or equal to “the hardness of the destruction target side”, the density of the voxel in the destruction range is updated as described above. That is, in this case, the voxel object in the destruction range is destroyed by a single destruction action. If “the hardness of the destroying side” is smaller than “the hardness of the destruction target side” and the difference between “the hardness of the destroying side” and “the hardness of the destruction target side” is less than a predetermined value, the amount of damage of the voxel in the destruction range is updated. For example, based on the hardness of the destroying side and/or the hardness of the material, the amount of damage of the voxel is set. If the amount of damage of the voxel accumulated by the destruction action performed multiple times exceeds the above endurance value, the density of the voxel is updated. That is, if “the hardness of the destroying side” is smaller than “the hardness of the destruction target side” and the difference between “the hardness of the destroying side” and “the hardness of the destruction target side” is less than the predetermined value, it is not that the density of the voxel in the destruction range is updated by a single destruction action (the voxel object is destroyed), but the density is updated by the destruction action performed multiple times. If, on the other hand, “the hardness of the destroying side” is smaller than “the hardness of the destruction target side” and the difference between “the hardness of the destroying side” and “the hardness of the destruction target side” is greater than or equal to the predetermined value, the amount of damage is not updated for the voxel in the destruction range, and the density is not updated for the voxel in the destruction range, either. In this case, even if the destruction action performed multiple times hits a voxel object, the voxel object is not destroyed.

For example, suppose that “the hardness of the destroying side” set for a first destruction action is “2” and the hardness of the material of a voxel (the hardness of the destruction target side) is “3”. In this case, since “the hardness of the destroying side” is smaller than “the hardness of the destruction target side” and the difference between “the hardness of the destroying side” and “the hardness of the destruction target side” is less than the predetermined value, the amount of damage of a voxel included in the destruction range set in accordance with the voxel object hit by the first destruction action is updated. The first destruction action is performed multiple times, whereby the amount of damage of the voxel included in the destruction range is accumulated. If the amount of damage of the voxel exceeds the endurance value, the density of the voxel is updated. Specifically, as described above, the density of a voxel completely included in the destruction range is set to “0”, and the density of a voxel partially included in the destruction range is decreased to a value less than the upper limit value.

If “the hardness of the destroying side” set for a second destruction action is “4” and “the hardness of the destruction target side” is “3”, a voxel object is destroyed by a single second destruction action. That is, in this case, since “the hardness of the destroying side” is greater than “the hardness of the destruction target side”, if the second destruction action hits a voxel object, the update of the amount of damage is omitted, and the density of a voxel included in the destruction range is updated.

If “the hardness of the destroying side” set for a third destruction action is “1” and “the hardness of the destruction target side” is “3”, and even if the third destruction action is performed multiple times, a voxel object is not destroyed. That is, in this case, since “the hardness of the destroying side” is smaller than “the hardness of the destruction target side” and the difference between “the hardness of the destroying side” and “the hardness of the destruction target side” is greater than or equal to the predetermined value, and even if the third destruction action hits a voxel object, the amount of damage and the density of a voxel are not updated.

### [3. Specific Example of Processing by Game System]

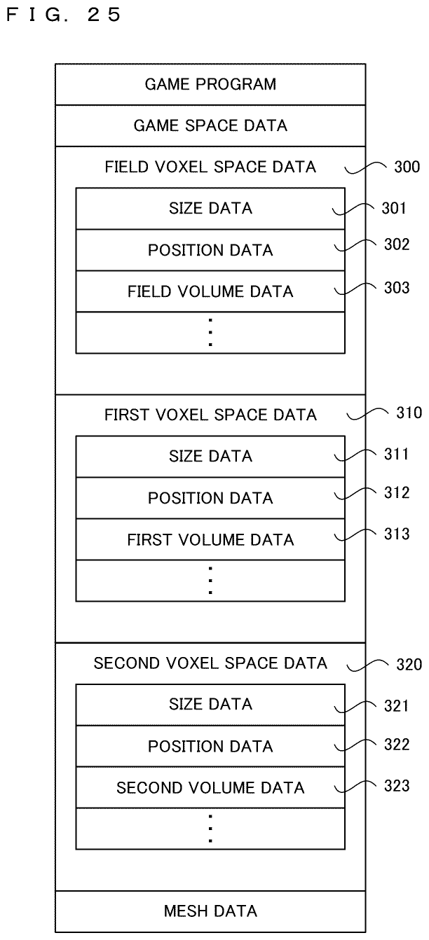

Next, with reference to FIGS. 25 to 27, a specific example of information processing by the game system 1 is described.

FIG. 25 is a diagram showing examples of various pieces of data used in the information processing by the game system 1. As shown in FIG. 25, the game system 1 stores a game program, game space data, field voxel space data 300, first voxel space data 310, second voxel space data 320, and mesh data.

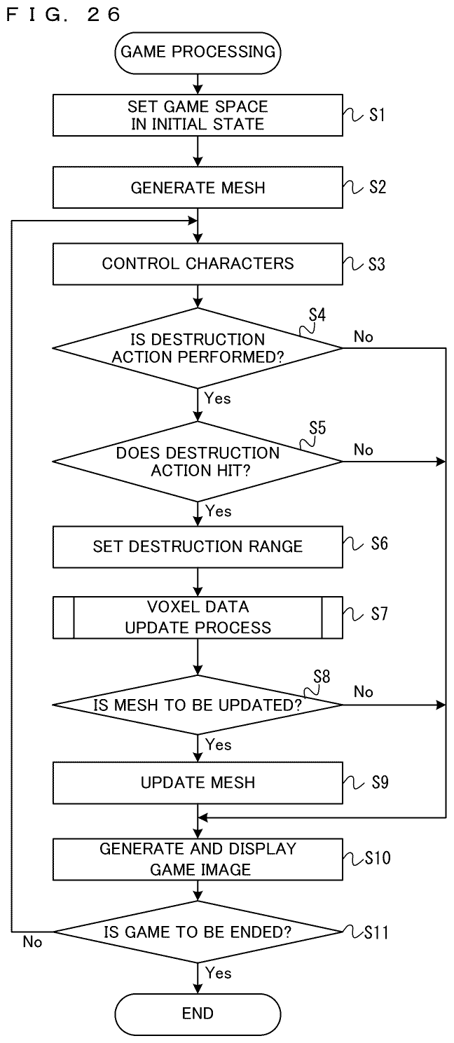

The game program is a program for executing game processing according to the exemplary embodiment (specifically, game processing shown in FIG. 26). The game program is stored in advance in a storage medium attached to the slot 23 or the flash memory 84 and is loaded into the DRAM 85 when the game is executed.

The game space data is data for defining the game space and includes data indicating the above XYZ coordinate system.

The field voxel space data 300 is data regarding the entirety of the field voxel space. In the exemplary embodiment, a plurality of game stages are prepared, and initial field voxel space data is prepared with respect to each game stage. As shown in FIG. 25, the field voxel space data 300 includes size data 301. The size data 301 indicates the length of a side of each voxel in the field voxel space. For example, the length of a side of each voxel in the field voxel space is 1 m. In the exemplary embodiment, the length of a side of each voxel in the field voxel space is the same, regardless of the type of the game stage. The length of a side of each voxel in the field voxel space may differ in accordance with the type of the game stage. The field voxel space data 300 also includes position data 302. The position data 302 is data indicating the position and the rotation of the field voxel space in the game space. In the exemplary embodiment, the field voxel space is fixed to the game space.

The field voxel space data 300 also includes field volume data 303. The field volume data 303 includes voxel data of each voxel in the field voxel space. Voxel data is set for each voxel, and a mesh is generated based on the voxel data, whereby a terrain is formed in the game space. In the storage medium attached to the slot 23 or the flash memory 84, the initial field volume data 303 is stored in advance with respect to each game stage (with respect to each piece of field voxel space data 300). When the game starts, the field volume data 303 stored in the storage medium attached to the slot 23 or the flash memory 84 is loaded into the DRAM 85. Consequently, an initial terrain is formed. Each piece of voxel data included in the field volume data 303 stored in the DRAM 85 is changed during the execution of the game, whereby the terrain is changed.

The first voxel space data 310 is data regarding the above voxel space VLa placed in the game space. The first voxel space data 310 includes size data 311, position data 312, and first volume data 313. The size data 311 includes data indicating the length of a side of each voxel in the voxel space VLa and data indicating the number of voxels in the directions of the axes (the Xa, Ya, and Za axes) of the voxel space VLa. For example, the length of a side of each voxel in the voxel space VLa is “1 m”. The size of the voxel space VLa in the game space is determined based on the size data 311. The position data 312 is data indicating the position and the rotation of the voxel space VLa in the game space. For example, the position data 312 includes coordinate data indicating a position in the game space and vector data indicating the directions of the axes (the Xa, Ya, and Za axes) of the voxel space VLa in the game space. The position data 312 is changed, whereby the position and/or the orientation of the voxel space VLa (e.g., the rock object A) in the game space are changed. The first volume data 313 is data for representing the rock object A. With respect to each voxel included in the voxel space VLa, the first volume data 313 holds voxel data indicating the presence of an object. That is, the first volume data 313 includes voxel data of each voxel included in the voxel space VLa. Voxel data is set for each voxel in the voxel space VLa, and a mesh is generated based on the voxel data, whereby the rock object A is formed.

The second voxel space data 320 is data regarding the above voxel space VLb placed in the game space. The second voxel space data 320 includes size data 321, position data 322, and second volume data 323. The size data 321 includes data indicating the length of a side of each voxel in the voxel space VLb and data indicating the number of voxels in the directions of the axes (the Xb, Yb, and Zb axes) of the voxel space VLb. For example, the length of a side of each voxel in the voxel space VLb is “0.5 m”. The size of the voxel space VLb in the game space is determined based on the size data 321. The position data 322 is data indicating the position and the rotation of the voxel space VLb in the game space. For example, the position data 322 includes coordinate data indicating a position in the game space and vector data indicating the directions in the axes (the Xb, Yb, and Zb axes) of the voxel space VLb in the game space. The position data 322 is changed, whereby the position and/or the orientation of the voxel space VLb (e.g., the enemy object B) in the game space are changed. The second volume data 323 is data for representing the enemy object B. With respect to each voxel included in the voxel space VLb, the second volume data 323 holds voxel data indicating the presence of an object. That is, the second volume data 323 includes voxel data of each voxel included in the voxel space VLb. Voxel data is set for each voxel in the voxel space VLb, and a mesh is generated based on the voxel data, whereby the enemy object B is formed.

The mesh data is data indicating a mesh set for a voxel object placed in the game space. The mesh data includes, for example, data indicating the position of each vertex in the mesh. The mesh data is generated based on the volume data 303, 313, and 323 and the like.

The game system 1 stores data of the above property information and texture information, data regarding various characters that appear in the game, and the like as data stored in advance before the execution of the game processing in addition to the data shown in FIG. 25. The game system 1 also stores 3D object data indicating a 3D object different from a voxel object (e.g., the player character PC and parts such as the hands and feet of the enemy object B). Voxel space data is stored with respect to each voxel object capable of moving in the game space. For example, data of a voxel space relating to the weapon object C is stored.

FIG. 26 is a flow chart showing an example of the flow of the game processing executed by the game system 1. The game processing shown in FIG. 26 is started in accordance with, for example, an instruction to start the game given by the player.

In the exemplary embodiment, the description is given on the assumption that the processes of steps shown in FIG. 26 are executed by the processor 81 of the main body apparatus 2 executing the game program stored in the game system 1. In another exemplary embodiment, however, some of the processes of the above steps may be executed by a processor (e.g., a dedicated circuit or the like) different from the processor 81. Further, in a case where the game system 1 can communicate with another information processing apparatus (e.g., a server), some of the processes of the steps shown in FIG. 26 may be executed by the other information processing apparatus. The processes of all of the steps shown in FIG. 26 are merely illustrative. Thus, the processing order of the steps may be changed, or another process may be performed in addition to (or instead of) the processes of all of the steps, so long as similar results are obtained.

The processor 81 executes the processes of steps shown in FIG. 26 using a memory (e.g., the DRAM 85). That is, the processor 81 stores information (in other words, data) obtained in the processing steps in the memory, and if the information is used in the subsequent processing steps, reads the information from the memory and uses the information.

As shown in FIG. 26, in step S1, the processor 81 sets the game space in an initial state. Specifically, the processor 81 acquires the field voxel space data indicating a terrain in the game space in the initial state and stores a part or the entirety of the acquired field voxel space data in the DRAM 85. The field voxel space data indicating the terrain in the game space in the initial state is stored in, for example, a storage medium attached to the slot 23 of the main body apparatus 2. The field voxel space data includes the field volume data 303 (voxel data) indicating the terrain. The processor 81 reads the voxel space data regarding other voxel objects (the first voxel space data 310, the second voxel space data 320, and the like) from the above storage medium and stores the voxel space data in the DRAM 85. The first voxel space data 310 includes the first volume data 313 (voxel data) indicating the rock object A. The second voxel space data 320 includes the second volume data 323 (voxel data) indicating the enemy object B. The processor 81 also reads 3D object data from the above storage medium, sets the initial position and the orientation of a 3D object, and stores the initial position and the orientation in the DRAM 85. The processor 81 also sets the initial position and the orientation of the virtual camera and stores the initial position and the orientation in the DRAM 85.

The voxel data to be written to the DRAM 85 may be voxel data of a partial range used to generate a game image in voxel data of the entire range of the game space. The processor 81 may generate an image of an object using, for example, pieces of voxel data of voxels included in a partial range (e.g., a range within a predetermined distance from the position of the virtual camera) of the game space. If voxel data regarding the partial range of the game space is written, a process similar to that of the above step S1 is executed at an appropriate timing during the execution of the series of processes of steps S2 to S11 (e.g., the timing when the position of the virtual camera moves by a predetermined distance or more).

In step S2, the processor 81 generates a mesh regarding each voxel object. The mesh is generated in accordance with the method described in the above “[2-2. Mesh]”. Specifically, based on the pieces of volume data stored in the DRAM 85 in step S1, the processor 81 generates a mesh representing each voxel object. Consequently, a terrain object is constructed in the game space, and the enemy object B is also placed in the game space. For example, based on a plurality of pieces of voxel data included in the field volume data 303, the processor 81 generates a polygon mesh between a voxel for which a value indicating that an object is present is set and a voxel for which a value indicating that an object is not present is set. An example of a specific method for determining the vertex positions is as described above with reference to FIG. 14. Based on a plurality of pieces of voxel data included in the first volume data 313, the processor 81 also generates a polygon mesh between a voxel for which a value indicating that an object is present is set and a voxel for which a value indicating that an object is not present is set. Consequently, a polygon mesh representing the rock object A is generated. Based on a plurality of pieces of voxel data included in the second volume data 323, the processor 81 also generates a polygon mesh between a voxel for which a value indicating that an object is present is set and a voxel for which a value indicating that an object is not present is set. Consequently, a polygon mesh representing the enemy object B is generated. After step S2, the game is started, and the processes of steps S3 to S11 are repeatedly executed at predetermined frame time intervals (e.g., 1/60-second intervals) during the game.

In step S3, the processor 81 controls the actions of various objects (e.g., the player character PC and the enemy object B) that appear in the game space. For example, based on operation data received from the controllers 3 and 4, the processor 81 moves the player character PC and causes the player character PC to perform a predetermined action (the destruction action, a jump, or the like). The destruction action of the player character PC may be a punch, a kick, the throwing of a bullet, or the like. Based on an algorithm determined in the game program, the processor 81 moves the enemy object B and causes the enemy object B to perform the destruction action (the swinging or throwing of the weapon object C or the like). After step S3, the process of step S4 is executed.

In step S4, based on operation data from the controllers, the processor 81 determines whether or not the destruction action is performed by the player character PC. Specifically, based on the operation data from the controllers, it is determined whether or not a predetermined button of the left controller 3 or the right controller 4 is pressed. If the result of the determination in step S4 is affirmative, the process of step S5 is executed. If, on the other hand, the result of the determination in step S4 is negative, the process of step S10 is executed.

In step S5, the processor 81 determines whether or not the destruction action hits a voxel object. Here, for example, it is determined whether or not the destruction action of the player character PC hits a terrain object or the enemy object B. The terrain object is the rock object A, the terrain object 210 representing the ground, the terrain object 220 representing a rock pile, or the like. The determination of whether or not the destruction action hits the voxel object is made by a physical determination between the object on the destroying side and the voxel object on the destruction target side. For example, in a case where the player character PC performs a punch, the object on the destroying side is the first of the player character PC. In a case where the player character PC throws a bullet, the object on the destroying side is the thrown bullet. The voxel object on the destruction target side is the terrain object or the enemy object B, and a determination mesh is generated. The determination mesh may be the same as a display mesh, or a determination mesh coarser than the display mesh may be prepared. A collision determination is made between the determination mesh and the object on the destroying side, and it is determined whether or not the determination mesh and the object on the destroying side hit each other. If the result of the determination in step S5 is affirmative, the process of step S6 is executed. If, on the other hand, the result of the determination in step S5 is negative, the process of step S10 is executed.

In step S6, the processor 81 sets a destruction range in accordance with the voxel object hit by the destruction action. For example, if the destruction action hits the terrain object, the processor 81 sets the first destruction range based on the position hit by the destruction action. For example, if the destruction action hits the enemy object B, the processor 81 sets the second destruction range based on the position hit by the destruction action. In the game space, the second destruction range is narrower than the first destruction range. After step S6, the process of step S7 is executed.

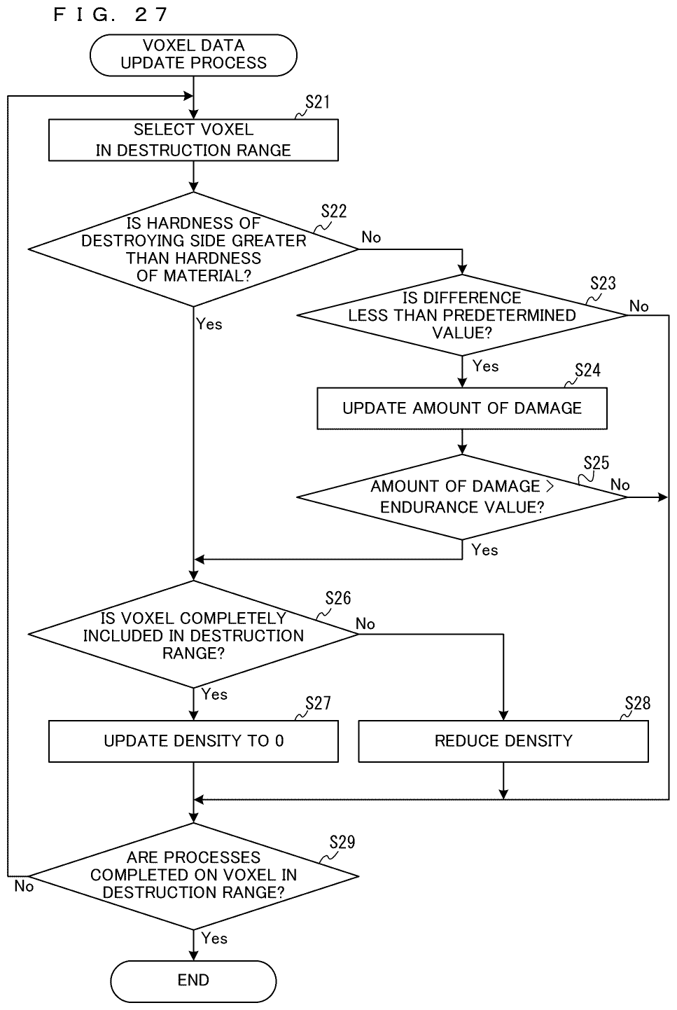

In step S7, the processor 81 executes a voxel data update process on the voxel object hit by the destruction action. With reference to FIG. 27, the voxel data update process in step S7 is described below.

FIG. 27 is a flow chart showing an example of the voxel data update process in step S7. The process shown in FIG. 27 is performed on voxels included in a voxel space of the voxel object hit by the destruction action (in other words, voxels in the volume data indicating the voxel object hit by the destruction action).

In step S21, the processor 81 selects a single voxel included in the destruction range set in step S6 among the voxels in the volume data indicating the voxel object hit by the destruction action. Here, a voxel completely included in the destruction range or a voxel partially included in the destruction range is selected. For example, if the destruction action hits the rock object A, a single voxel included in the first destruction range set in step S6 among the voxels in the voxel space VLa is selected. After step S21, the process of step S22 is executed.

In step S22, the processor 81 determines whether or not the hardness of the destroying side determined in accordance with the destruction action is greater than or equal to the hardness of the material indicated by the material data included in the voxel data. If the result of the determination in step S22 is affirmative, next, the process of step S26 is executed. If, on the other hand, the result of the determination in step S22 is negative, next, the process of step S23 is executed.

In step S23, the processor 81 determines whether or not the difference between the hardness of the destroying side and the hardness of the material (the hardness of the destruction target side) is less than the predetermined value. If the result of the determination in step S23 is affirmative, next, the process of step S24 is executed. If, on the other hand, the result of the determination in step S23 is negative, next, the process of step S29 is executed.

In step S24, the processor 81 updates the amount of damage of the selected voxel. For example, based on the hardness of the destroying side and the hardness of the material, the amount of damage is updated. After step S24, the process of step S25 is executed.

In step S25, the processor 81 determines whether or not the updated amount of damage of the voxel exceeds the endurance value determined in advance for the material. If the result of the determination in step S25 is affirmative, next, the process of step S26 is executed. If, on the other hand, the result of the determination in step S25 is negative, next, the process of step S29 is executed.

In step S26, the processor 81 determines whether or not the selected voxel is completely included in the destruction range set in step S6. For example, based on a Signed Distance from the surface of the set destruction range, it is determined whether or not the selected voxel is completely included in the destruction range. For example, if the Signed Distance has a negative value, it is determined that the voxel is included in the destruction range. If the result of the determination in step S26 is affirmative, next, the process of step S27 is executed. If, on the other hand, the result of the determination in step S26 is negative, next, the process of step S28 is executed.

In step S27, as the destruction process, the processor 81 updates the density of the selected voxel from a value indicating that a voxel object is present (e.g., “255”) to a value indicating that a voxel object is not present (e.g., “0”).

In step S28, as the destruction process, the processor 81 decreases the density of the selected voxel. Specifically, a voxel for which the determination is NO in step S26 is a voxel partially included in the set destruction range. Here, the density of the voxel partially included in the destruction range is decreased to a value smaller than the upper limit value. After step S28, the process of step S29 is executed.

In step S29, the processor 81 determines whether or not the processes of the above steps S21 to S28 are completed on all the voxels included in the destruction range among the plurality of voxels in the voxel space relating to the voxel object hit by the destruction action. If the result of the determination in step S29 is affirmative, the process shown in FIG. 27 ends. If, on the other hand, the result of the determination in step S29 is negative, the processor 81 changes the voxel as the target to be processed among the voxels in the destruction range and executes the process of step S21 again.

Referring back to FIG. 26, after the process of step S7, the processor 81 executes the process of step S8.

In step S8, the processor 81 determines whether or not a mesh is to be updated. Here, if voxel data is updated in step S7, the processor 81 determines that a mesh is to be updated. If the result of the determination in step S8 is affirmative, the process of step S9 is executed. If, on the other hand, the result of the determination in step S8 is negative, the process of step S10 is executed. Even if voxel data is updated in step S7, but if an updated voxel is not present in the image capturing range of the virtual camera, the processor 81 may determine in step S8 that a mesh is not to be updated. That is, even if the destruction action hits a terrain object or the enemy object B and a part or the entirety of the terrain object or the enemy object B is destroyed, but if a voxel object in the game space that can be viewed from the virtual camera is not destroyed, a mesh may not be updated. When the processing load is high, the update of the mesh may not be performed in this frame, and may be carried over to the next frame and subsequent frames.

In step S9, the processor 81 updates a mesh regarding a voxel object of which voxel data is changed in step S7. Specifically, based on the updated voxel data, the vertex positions of the mesh are recalculated. The updated mesh is stored as mesh data in the DRAM 85. That is, based on the voxel data updated in step S7, the processor 81 generates the mesh of the destroyed voxel object. Consequently, during the game, it is possible to dynamically change the mesh of a voxel object (the terrain object or the enemy object B) on which the destruction action is performed. In step S9, the vertices of the mesh of only a portion where the voxel data is updated are recalculated. Regarding the mesh of a portion where the voxel data is not updated, the vertex positions of the mesh generated in step S2 are used. As described above, the mesh is recalculated only regarding the updated voxel data, and therefore, it is possible to decrease the processing load. In another exemplary embodiment, in step S9, based on all the pieces of voxel data in the game space (or all the pieces of voxel data in the image capturing range of the virtual camera) including both voxel data that is updated and voxel data that is not updated, the vertex positions of the mesh may be recalculated. After step S9, the process of step S10 is executed.

In step S10, the processor 81 generates a game image representing the game space based on the virtual camera and displays the generated game image on the display device. Specifically, the processor 81 generates a game image of the mesh generated in step S2 or S9 when viewed from the position of the virtual camera. Consequently, a game image representing the game space including a voxel object and another 3D object (e.g., the player character PC) is generated. Then, the processor 81 displays the generated game image on the display device. After step S10, the process of step S11 is executed.

In step S11, the processor 81 determines whether or not the game is to be ended. For example, the processor 81 determines whether or not an instruction to end the game is given by the user. If the result of the determination in step S11 is negative, the process of step S3 is executed again. From this point onward, the series of processes of steps S3 to S11 are repeatedly executed until it is determined in step S11 that the game is to be ended. If, on the other hand, the result of the determination in step S11 is affirmative, the processor 81 ends the game processing shown in FIG. 26.

In FIG. 26, a description has been given of a case where the player character PC performs the destruction action and destroys a terrain object or the enemy object B. In addition to the above process, various other processes are performed. For example, the enemy object B may perform the destruction action, whereby a terrain object may be destroyed by a method similar to that described above. That is, if the destruction action of the enemy object B hits the terrain object, the first destruction range relating to the terrain object is set based on the position hit by the destruction action, and the terrain object in the first destruction range is destroyed. Not only the destruction of the terrain object but also the addition of a terrain object may be performed. For example, if the player character PC performs a predetermined action, a terrain object may be newly added. The addition of the terrain object is performed by updating voxel data as described above. For example, voxel data of a voxel for which a value indicating that a terrain object is not present is set may be rewritten with a value indicating that a terrain object is present, whereby a terrain object may be added to the inside of the game space. In this case, voxel data of a voxel in the field voxel space may be updated, whereby a new terrain object may be added. A different voxel space may be newly set in the game space, whereby voxel data of a voxel in the different voxel space may be set, whereby a new terrain object may be added. For example, the destruction action may be performed on a terrain object generated based on the field volume data 303, whereby the densities of a plurality of voxels included in the field volume data 303 may be set to “0” (a part of the terrain may be erased), a voxel space different from the field voxel space may also be newly set, and the densities of a plurality of voxels in the different voxel space may be set to values greater than a reference value. Consequently, a part of the terrain object is separated, and a new terrain object capable of moving in the game space is generated. Not only the destruction of the enemy object B but also the addition of another enemy object may be performed. The addition of the enemy object is performed by setting a voxel space relating to the new enemy object in the game space and setting voxel data of a voxel in the voxel space.

The processes shown in the above flow charts are merely illustrative, and the order and the contents of the processes, the values used in the determinations, and the like may be appropriately changed.

As described above, in the exemplary embodiment, the field volume data 303, the first volume data 313, and the second volume data 323 are stored in a memory. The field volume data 303 is data for representing a terrain object and holds voxel data indicating the presence of an object with respect to each voxel included in the field voxel space placed in the game space. The first volume data 313 is data for representing the rock object and holds voxel data indicating the presence of an object with respect to each voxel included in the voxel space VLa placed in the game space. The second volume data 323 is data for representing the enemy object and holds voxel data indicating the presence of an object with respect to each voxel included in the voxel space VLb placed in the game space. For example, if the destruction action is performed on the terrain object 210 or 220 based on an operation input of the player, voxel data of a voxel included in the first destruction range set based on the position hit by the destruction action in the field volume data 303 is updated. If the destruction action is performed on the rock object based on an operation input of the player, voxel data of a voxel included in the first destruction range set based on the position hit by the destruction action in the first volume data 313 is updated. If the destruction action is performed on the enemy object based on an operation input of the player, voxel data of a voxel included in the second destruction range set based on the position hit by the destruction action in the second volume data 323 is updated. Based on the field volume data 303, the first volume data 313, and the second volume data 323, polygon meshes are generated.

Consequently, the destruction range can be varied with respect to each object hit by the destruction action. The second destruction range is narrower than the first destruction range, and therefore, a wider range can be destroyed by the destruction action regarding the terrain object, and a narrower range can be destroyed by the destruction action regarding the enemy object.

In the exemplary embodiment, the density indicating the occupancy of an object inside the virtual space defined by a voxel is set as voxel data. For example, if the destruction action hits the rock object, the above degree (density) of a voxel included in the first destruction range among a plurality of pieces of voxel data included in the first volume data 313 is decreased. If the destruction action hits the enemy object, the above degree (density) of a voxel included in the second destruction range among a plurality of pieces of voxel data included in the second volume data 323 is decreased.

If the destruction action hits the terrain object, the density of at least one of a plurality of voxels included in the first destruction range is set to a value indicating that an object is not present (specifically, “0”). Specifically, the density of a voxel completely included in the first destruction range is set to a value indicating that an object is not present (specifically, “0”). The density of a voxel partially included in the first destruction range is decreased to a value less than the upper limit value. Similarly, the density of at least one of a plurality of voxels included in the second destruction range is set to a value indicating that an object is not present (specifically, “0”). Specifically, the density of a voxel completely included in the second destruction range is set to a value indicating that an object is not present (specifically, “0”). The density of a voxel partially included in the second destruction range is decreased to a value less than the upper limit value. Consequently, the density of a voxel can be varied between the inside of the destruction range and the surface of the destruction range. For example, the surface of the destruction range can have a smooth natural shape.

In the exemplary embodiment, voxel data further includes the material data indicating the material (a rock, soil, sand, or the like) of an object and the amount of damage. If the destruction action hits a voxel object (a terrain object or the enemy object), based on the type of the destruction action and the hardness of the material indicated by the material data, the amount of damage of the voxel is updated. If the amount of damage caused to the voxel exceeds the endurance value set for the material, the density of the voxel is updated. Consequently, for example, it is possible to destroy an object by performing a single destruction action or destroy an object by performing the destruction action multiple times. Thus, it is possible to create variations in the manner of destruction.

In the exemplary embodiment, the size of a single voxel in the voxel space VLb for representing the enemy object in the game space is smaller than the size of a single voxel in the field voxel space or the voxel space VLa in the game space for representing a terrain object. That is, the resolution of a voxel in the voxel space VLb for representing the enemy object is higher than the resolution of a voxel in the field voxel space or the voxel space VLa for representing the terrain object. Thus, it is possible to represent the enemy object more finely than the terrain object.

### Variations

While the exemplary embodiment has been described above, the exemplary embodiment is merely an example and may be modified as follows, for example.

For example, in the above exemplary embodiment, if the destruction action hits a terrain object, the first destruction range is set for the terrain object. If the destruction action hits the enemy object, the second destruction range smaller than the first destruction range is set for the enemy object. The same process may be performed on any other voxel object. For example, if the destruction action hits a first object, the first destruction range may be set for the first object. If the destruction action hits a second object, the second destruction range smaller than the first destruction range may be set for the second object. The types of voxel objects may be three or more types, and the destruction range may differ in accordance with these types of voxel objects.

In the above exemplary embodiment, the destruction range differs in accordance with the type of the voxel object hit by the destruction action. The destruction range may differ in accordance with not only the type of the voxel object but also the type of the destruction action, for example. Also in this case, if the same destruction action is performed, the destruction range differs in accordance with the type of the object hit by the destruction action. For example, if a punch hits a terrain object, the first destruction range in the terrain object may be destroyed. If a punch hits the enemy object, the second destruction range in the enemy object may be destroyed. If a kick hits a terrain object, the third destruction range in the terrain object may be destroyed. If a kick hits the enemy object, a fourth destruction range in the enemy object may be destroyed.

In the above exemplary embodiment, the determination of whether or not the destruction action hits a voxel object is made based on a determination mesh or a display mesh generated based on voxel data. In another exemplary embodiment, the determination of whether or not the destruction action hits a voxel object may be made based on voxel data.

In the above exemplary embodiment, the size of each voxel of a first voxel space (e.g., the field voxel space or the voxel space VLa) for representing the first object (e.g., a terrain object) in the game space is larger than the size of each voxel of a second voxel space (e.g., the voxel space VLb) for representing the second object (e.g., the enemy object) in the game space. The first destruction range when the destruction action hits the first object is greater than the second destruction range when the destruction action hits the second object. In another exemplary embodiment, the size of each voxel of the first voxel space may be the same as the size of each voxel of the second voxel space. Also in this case, in the game space, the first destruction range when the destruction action hits the first object may be greater than the second destruction range when the destruction action hits the second object.

In the above exemplary embodiment, if the destruction action on the first object is performed, voxel data of a voxel included in the first destruction range is updated, and if the destruction action on the second object is performed, voxel data of a voxel included in the second destruction range is updated, whereby the first object or the second object is destroyed. In another exemplary embodiment, if any event occurs for an object, a range relating to the type of the object may be set, and voxel data of a voxel included in the set range may be updated. That is, if a first event for the first object occurs, a first range may be set based on the position where the first event occurs, and voxel data of a voxel included in the first range may be updated (decreased or increased). If a second event for the second object occurs, a second range based on the position where the second event occurs may be set, and voxel data of a voxel included in the second range may be updated (decreased or increased). An event may be the state where the action of the player character PC or the enemy object as described above is performed on a voxel object. For example, an event may be the state where a punch of the player character PC hits a voxel object, or the state where a bullet thrown by the player character PC hits a voxel object. An event may be an event that occurs without depending on the action of the player character PC or the enemy object, such as the eruption of a volcano or the fall of a stone. For example, an event may occur in accordance with time. An event may be an event where an object is newly generated. In this case, if the event occurs, voxel data of a voxel included in a range set based on the position where the event occurs may be updated (the density of the voxel data may be increased), whereby an object may be newly generated.

In the above exemplary embodiment, among voxels of a voxel object, the density of a voxel completely included in the destruction range is set to “0”, thereby setting a value indicating that an object is not present in the voxel. The density of a voxel partially included in the destruction range is decreased to a value less than the upper limit value. The voxel completely included in the destruction range may be set to a value indicating that an object is not present, and the voxel partially included in the destruction range may be updated to any value so long as the proportion (degree) of the occupancy of the object is decreased.

In the above exemplary embodiment, the density of a voxel in the destruction range is set to “0”, thereby setting a value indicating that an object is not present in the voxel. Consequently, a portion in the destruction range in a voxel object is erased, and the voxel object is destroyed. The destruction (erasure) of the voxel object may be set not only by setting the density of voxel data to “0”, but also by setting the density to another value. For example, regarding the density, “a value indicating that an object is not present” may not be limited to “0”, and may be any value less than a reference value (e.g., 128). Regarding the density, “a value indicating that an object is present” may be a value in the range from 1 to 255, or may be a value greater than or equal to the reference value. The destruction (or the generation) of a voxel object may be performed not only by changing the density of voxel data, but also by another method. For example, a flag indicating the presence or absence of an object may be stored in voxel data, and if the flag is set to ON, it may be indicated that an object is present in the voxel. If the flag is set to OFF, it may be indicated that an object is not present in the voxel (e.g., a cavity). If the material data is stored in voxel data, it may be indicated that an object formed of the material indicated by the material data is present in the voxel. Conversely, if the material data is not stored in voxel data, it may be indicated that an object is not present in the voxel.

The above processes may be executed not only by the game system 1 but also by any other information processing apparatus or information processing system. The information processing system may include a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute image processing comprising:
storing in a memory
first volume data that is data for representing a first object in a virtual space and holds voxel data indicating presence of an object with respect to each voxel included in a first voxel space placed in the virtual space, and
second volume data that is data for representing a second object in the virtual space and holds the voxel data with respect to each voxel included in a second voxel space placed in the virtual space;
if a first event for the first object occurs based on an operation input of a player, updating in the first volume data the voxel data of a voxel included in a first range set based on a position where the first event occurs;
if a second event for the second object occurs based on an operation input of the player, updating in the second volume data the voxel data of a voxel included in a second range set based on a position where the second event occurs; and
based on the first volume data and the second volume data, at least drawing a polygon mesh representing surfaces of the first object and the second object, thereby generating an image of the virtual space.

2. The one or more non-transitory computer-readable media according to claim 1, wherein
the voxel data includes a value indicating an occupancy of an object inside a space defined by a voxel, and
the image processing further comprises:
if the first event occurs, updating the voxel data so that the degree of a voxel included in the first range decreases in the first volume data; and
if the second event occurs, updating the voxel data so that the degree of a voxel included in the second range decreases in the second volume data.

3. The one or more non-transitory computer-readable media according to claim 2, wherein
the image processing further comprises:
if the first event occurs, updating the voxel data so that at least one of a plurality of voxels included in the first range in the first volume data is set to a value indicating that the first object is not present; and
if the second event occurs, updating the voxel data so that at least one of a plurality of voxels included in the second range in the second volume data is set to a value indicating that the second object is not present.

4. The one or more non-transitory computer-readable media according to claim 3, wherein
the image processing further comprises:
if the first event occurs, updating the voxel data so that a voxel completely included in the first range in the first volume data is set to a value indicating that the first object is not present, and the degree of a voxel partially included in the first range decreases; and
if the second event occurs, updating the voxel data so that a voxel completely included in the second range in the second volume data is set to a value indicating that the second object is not present, and the degree of a voxel partially included in the second range decreases.

5. The one or more non-transitory computer-readable media according to claim 2, wherein
the voxel data further includes material data indicating a material of an object and an amount of damage indicating caused damage, and
the image processing further comprises:
if the first event occurs, updating the amount of damage of a voxel included in the first range in the first volume data and further update a value indicating the degree of a voxel in which the amount of damage exceeds an upper limit set for the material; and
if the second event occurs, updating the amount of damage of a voxel included in the second range in the second volume data and further update a value indicating the degree of a voxel in which the amount of damage exceeds the upper limit set for the material.

6. The one or more non-transitory computer-readable media according to claim 1, wherein
a single voxel included in the first volume data and a single voxel included in the second volume data are different from each other in size defined in the virtual space.

7. The one or more non-transitory computer-readable media according to claim 1, wherein
the first object is a terrain in the virtual space, and
the first range is greater than the second range.

8. The one or more non-transitory computer-readable media according to claim 1, wherein
the second object is an object capable of moving in the virtual space by changing a position and/or an orientation of the second voxel space in the virtual space, and
the second range is smaller than the first range.

9. The one or more non-transitory computer-readable media according to claim 1, wherein
the image processing further comprises:
determining a vertex position of a polygon based on the voxel data between a voxel in which the first object or the second object is not present and a voxel in which the first object or the second object is present, thereby generating the polygon mesh; and
based on occurrence of the first event or the second event, recalculating a vertex of the polygon mesh in a range including a voxel in which at least the voxel data is updated.

10. The one or more non-transitory computer-readable media according to claim 1, wherein
the image processing further comprises
based on an operation input of the player, causing a player character to perform a destruction action for destroying the first object and the second object,
the first event is a state where the destruction action hits the first object, and
the second event is a state where the destruction action hits the second object.

11. An information processing system comprising: one or more processors that are configured to execute image processing comprising:
storing in a memory
first volume data that is data for representing a first object in a virtual space and holds voxel data indicating presence of an object with respect to each voxel included in a first voxel space placed in the virtual space, and
second volume data that is data for representing a second object in the virtual space and holds the voxel data with respect to each voxel included in a second voxel space placed in the virtual space;
if a first event for the first object occurs based on an operation input of a player, updates in the first volume data the voxel data of a voxel included in a first range set based on a position where the first event occurs;
if a second event for the second object occurs based on an operation input of the player, updating in the second volume data the voxel data of a voxel included in a second range set based on a position where the second event occurs; and
based on the first volume data and the second volume data, at least drawing a polygon mesh representing surfaces of the first object and the second object, thereby generating an image of the virtual space.

12. The information processing system according to claim 11, wherein
the voxel data includes a value indicating an occupancy of an object inside a space defined by a voxel, and
the image processing further comprises:
if the first event occurs, updating the voxel data so that the degree of a voxel included in the first range decreases in the first volume data; and
if the second event occurs, updating the voxel data so that the degree of a voxel included in the second range decreases in the second volume data.

13. The information processing system according to claim 12, wherein
the image processing further comprises:
if the first event occurs, updating the voxel data so that at least one of a plurality of voxels included in the first range in the first volume data is set to a value indicating that the first object is not present; and
if the second event occurs, updating the voxel data so that at least one of a plurality of voxels included in the second range in the second volume data is set to a value indicating that the second object is not present.

14. The information processing system according to claim 13, wherein
the image processing further comprises:
if the first event occurs, updating the voxel data so that a voxel completely included in the first range in the first volume data is set to a value indicating that the first object is not present, and the degree of a voxel partially included in the first range decreases; and
if the second event occurs, updating the voxel data so that a voxel completely included in the second range in the second volume data is set to a value indicating that the second object is not present, and the degree of a voxel partially included in the second range decreases.

15. The information processing system according to claim 12, wherein
the voxel data further includes material data indicating a material of an object and an amount of damage indicating caused damage, and
the image processing further comprises:
if the first event occurs, updating the amount of damage of a voxel included in the first range in the first volume data and further update a value indicating the degree of a voxel in which the amount of damage exceeds an upper limit set for the material; and
if the second event occurs, updating the amount of damage of a voxel included in the second range in the second volume data and further update a value indicating the degree of a voxel in which the amount of damage exceeds the upper limit set for the material.

16. The information processing system according to claim 11, wherein
a single voxel included in the first volume data and a single voxel included in the second volume data are different from each other in size defined in the virtual space.

17. The information processing system according to claim 11, wherein
the first object is a terrain in the virtual space, and
the first range is greater than the second range.

18. The information processing system according to claim 11, wherein
the second object is an object capable of moving in the virtual space by changing a position and/or an orientation of the second voxel space in the virtual space, and
the second range is smaller than the first range.

19. The information processing system according to claim 11, wherein
the image processing further comprises:
determining a vertex position of a polygon based on the voxel data between a voxel in which the first object or the second object is not present and a voxel in which the first object or the second object is present, thereby generating the polygon mesh; and
based on occurrence of the first event or the second event, recalculating a vertex of the polygon mesh in a range including a voxel in which at least the voxel data is updated.

20. The information processing system according to claim 11, wherein
the image processing further comprises
based on an operation input of the player, further causing a player character to perform a destruction action for destroying the first object and the second object,
the first event is a state where the destruction action hits the first object, and
the second event is a state where the destruction action hits the second object.

21. An information processing apparatus comprising: one or more processors that are configured to execute image processing comprising:
storing in a memory
first volume data that is data for representing a first object in a virtual space and holds voxel data indicating presence of an object with respect to each voxel included in a first voxel space placed in the virtual space, and
second volume data that is data for representing a second object in the virtual space and holds the voxel data with respect to each voxel included in a second voxel space placed in the virtual space;
if a first event for the first object occurs based on an operation input of a player, updating in the first volume data the voxel data of a voxel included in a first range set based on a position where the first event occurs;
if a second event for the second object occurs based on an operation input of the player, updating in the second volume data the voxel data of a voxel included in a second range set based on a position where the second event occurs; and
based on the first volume data and the second volume data, at least drawing a polygon mesh representing surfaces of the first object and the second object, thereby generating an image of the virtual space.

22. The information processing apparatus according to claim 21, wherein
the voxel data includes a value indicating an occupancy of an object inside a space defined by a voxel, and
the image processing further comprises:
if the first event occurs, updating the voxel data so that the degree of a voxel included in the first range decreases in the first volume data; and
if the second event occurs, updating the voxel data so that the degree of a voxel included in the second range decreases in the second volume data.

23. The information processing apparatus according to claim 22, wherein
the image processing further comprises:
if the first event occurs, updating the voxel data so that at least one of a plurality of voxels included in the first range in the first volume data is set to a value indicating that the first object is not present; and
if the second event occurs, updating the voxel data so that at least one of a plurality of voxels included in the second range in the second volume data is set to a value indicating that the second object is not present.

24. The information processing apparatus according to claim 23, wherein
the image processing further comprises:
if the first event occurs, updating the voxel data so that a voxel completely included in the first range in the first volume data is set to a value indicating that the first object is not present, and the degree of a voxel partially included in the first range decreases; and
if the second event occurs, updating the voxel data so that a voxel completely included in the second range in the second volume data is set to a value indicating that the second object is not present, and the degree of a voxel partially included in the second range decreases.

25. The information processing apparatus according to claim 22, wherein
the voxel data further includes material data indicating a material of an object and an amount of damage indicating caused damage, and
the image processing further comprises:
if the first event occurs, updating the amount of damage of a voxel included in the first range in the first volume data and further update a value indicating the degree of a voxel in which the amount of damage exceeds an upper limit set for the material; and
if the second event occurs, updating the amount of damage of a voxel included in the second range in the second volume data and further update a value indicating the degree of a voxel in which the amount of damage exceeds the upper limit set for the material.

26. The information processing apparatus according to claim 21, wherein
a single voxel included in the first volume data and a single voxel included in the second volume data are different from each other in size defined in the virtual space.

27. An information processing method for causing an information processing system to execute game processing, the information processing method causing the information processing system to execute:
reading from a storage medium
first volume data that is data for representing a first object in a virtual space and holds voxel data indicating presence of an object with respect to each voxel included in a first voxel space placed in the virtual space, and
second volume data that is data for representing a second object in the virtual space and holds the voxel data with respect to each voxel included in a second voxel space placed in the virtual space;
if a first event for the first object occurs based on an operation input of a player, updating in the first volume data the voxel data of a voxel included in a first range set based on a position where the first event occurs;
if a second event for the second object occurs based on an operation input of the player, updating in the second volume data the voxel data of a voxel included in a second range set based on a position where the second event occurs; and
based on the first volume data and the second volume data, at least drawing a polygon mesh representing surfaces of the first object and the second object, thereby generating an image of the virtual space.

28. The information processing method according to claim 27, wherein
the voxel data includes a value indicating an occupancy of an object inside a space defined by a voxel, and
the information processing method causes the information processing system to:
if the first event occurs, update the voxel data so that the degree of a voxel included in the first range decreases in the first volume data; and
if the second event occurs, update the voxel data so that the degree of a voxel included in the second range decreases in the second volume data.

29. The information processing method according to claim 28, wherein
the information processing method causes the information processing system to:
if the first event occurs, update the voxel data so that at least one of a plurality of voxels included in the first range in the first volume data is set to a value indicating that the first object is not present; and
if the second event occurs, update the voxel data so that at least one of a plurality of voxels included in the second range in the second volume data is set to a value indicating that the second object is not present.

30. The information processing method according to claim 29, wherein
the information processing method causes the information processing system to:
if the first event occurs, update the voxel data so that a voxel completely included in the first range in the first volume data is set to a value indicating that the first object is not present, and the degree of a voxel partially included in the first range decreases; and
if the second event occurs, update the voxel data so that a voxel completely included in the second range in the second volume data is set to a value indicating that the second object is not present, and the degree of a voxel partially included in the second range decreases.

31. The information processing method according to claim 28, wherein
the voxel data further includes material data indicating a material of an object and an amount of damage indicating caused damage, and
the information processing method causes the information processing system to:
if the first event occurs, update the amount of damage of a voxel included in the first range in the first volume data and further update a value indicating the degree of a voxel in which the amount of damage exceeds an upper limit set for the material; and
if the second event occurs, update the amount of damage of a voxel included in the second range in the second volume data and further update a value indicating the degree of a voxel in which the amount of damage exceeds the upper limit set for the material.

32. The information processing method according to claim 27, wherein
a single voxel included in the first volume data and a single voxel included in the second volume data are different from each other in size defined in the virtual space.
